(19) United States
(12) Patent Application Publication
(10) Pub. No.: US 2012/0158527 A1
(43) Pub. Date: Jun. 21, 2012

(54) Systems, Methods and/or Computer Readable Storage Media Facilitating Aggregation and/or Personalized Sequencing of News Video Content

(75) Inventors: Theodore Joseph Cannelongo, Twinsburg, OH (US); Philip Austin Cannelongo, Indianapolis, IN (US)

(73) Assignee: CLASS6IX, LLC, Twinsburg, OH (US)

(21) Appl. No.: 13/305,190

(22) Filed: Nov. 28, 2011

Related U.S. Application Data
(60) Provisional application No. 61/425,695, filed on Dec. 21, 2010.

(51) Int. Cl. G06F 17/30; G06F 15/16; G06Q 30/02

(52) U.S. Cl. 705/14.73; 707/748; 707/E17.005

(57) ABSTRACT

News content can be presented in accordance with systems and methods described herein. These systems and methods can include at least one download server that can be coupled to content providers that provide the news content. The download server can download at least part of the news content. The system can also include a database with information related to at least a subset of the downloaded news content and to one or more users. Additionally, the system can include a content delivery network that can store at least part of the downloaded news content and a web server that can be configured to present an item of the at least a portion of the downloaded news content to a user device. The item can be the highest scoring item selected in response to a database query, and the scoring can be based on a weighted average of metrics.

### CROSS-REFERENCE TO RELATED APPLICATIONS

This application claims the benefit of U.S. Provisional Patent application Ser. No. 61/425,695 entitled “Systems, Methods and/or Computer Readable Storage Media Facilitating Aggregation and/or Personalized Sequencing of News Video Content” and filed Dec. 21, 2010. The entirety of the above-noted application is incorporated by reference herein.

### TECHNICAL FIELD

The subject application relates generally to media distribution, and more specifically to distribution of video programming (e.g., news video programming)

### BACKGROUND

Systems and/or methods have been proposed for creating a personalized television viewing experience. However, these conventional systems and/or methods utilize explicit feedback or implicit interest profiles to display or propose content anticipated to be most desirable to the viewer. Further, these systems and/or methods are not viable platforms for aggregating and/or distributing breaking news content for various reasons.

Some conventional systems utilize a user-supplied set of categories or keywords of interest, possibly ranked or weighted subjectively by the user. These are compared against a list of tagged videos to determine if the story is of interest to the viewer. If the story is of interest to the viewer, the story is presented for selection or automatically displayed as part of a playlist. While this might help to highlight stories related to hobbies or general interests and/or can be used to avoid specific categories entirely—world news or sports, for example—this methodology will either require a fair amount of ongoing user maintenance in order to capture new topics of interest or will lack a suitable level of granularity. Approaches that utilize user-supplied keywords require a user to have an awareness of a given story before the user can request videos related to that topic, mandating that the user supplement the user's news gathering with information from another source. The user will likely miss many current events otherwise.

Some conventional systems look at user activity and attempt to infer the user's interests from this information. If, for instance, a viewer watches a story about basketball, the system will assume the user likes the subject and will show them more videos related to basketball. If they chose not to watch the story, the system might accordingly assume the user has no interest and will avoid presenting videos of similar subject to the user in the future. This approach seems feasible in concept and might be viable in certain non-news environments, such as video sharing or educational websites in which a user might wish to fully explore a specific subject of interest. However, most television news viewers will desire a wide variety of interspersed subject matter that can all be of interest. The stories seen first can end up creating a rather narrow profile of the viewer's overall interests. In filtering out other videos the system simply does not realize are of interest, it becomes nearly impossible for the viewer to expand their interest profile accordingly without some means of manually going out and searching for other items, which again requires the user to have an awareness of them.

In response to this problem, other conventional systems look at other similar viewers' activity and present to any given viewer in the cluster videos that are regularly being watched by others in the cluster. These clusters are often created around those with largely similar interest profiles. Given that fact, such interest clusters offer little additional value over simply looking at the individual's own profile. While it offers some chance that a tangentially related subject of interest to a number of viewers in the cluster might be introduced to the remainder, the reality is that a cluster may become somewhat of a topic silo. The items most watched by the cluster are the items that are presented to the cluster based on initially defined and/or subsequently refined interest profiles. They will not have much opportunity to explore beyond those subjects without manual intervention and/or searching.

### SUMMARY

A simplified summary is provided herein to help enable a basic or general understanding of various aspects of one or more of the examples and non-limiting embodiments that follow in the more detailed description and/or the accompanying drawings. This summary is not intended, however, as an extensive or exhaustive overview. Further, this summary is not intended to identify key features or essential features of the claimed subject matter, nor is it intended to be used to limit the scope of the claimed subject matter. Finally, the claimed subject matter is not limited to implementations that solve any or all of the noted disadvantages discussed in the Background. Instead, the sole purpose of this summary is to present some concepts related to some examples and non-limiting embodiments in a simplified form as a prelude to the more detailed description of the various embodiments that follow.

While not limiting, as used herein, the terms “video/videos” are intended to include an encoded content video file. Types of video include, but are not limited to, MP4 and Flash video, for example. As used herein, the terms “story/stories” and “item/items” each are intended to include metadata associated with a specific video, or metadata associated with a specific video and coupled with the video as a combined entity. In some embodiments, metadata can include title, description, and one or more other fields stored in the [items] table (as described herein). Additionally, as further clarification, a “news” descriptor is used from time to time to modify one or more of the terms “video/videos,” “story/stories,” or “item/items” because the metrics described herein relate to news items in some embodiments. However, the metrics need not be limited to descriptions for news items and can describe other types of non-news content as well. All such embodiments are intended to be encompassed within the scope of the innovation described herein.

In one aspect, the subject innovation can include a system that can present news content. The system can include at least one download server that can be communicatively coupled to one or more content providers that provide the news content. The at least one download server can download at least a portion of the news content. The system can also include a database that can comprise information related to at least a subset of the downloaded news content and to one or more users. Additionally, the system can include a content delivery network that can store at least a portion of the downloaded news content and a web server that can be configured to present an item of at least a portion of the downloaded news content to a user device. The item can be selected by the database as a highest scoring item in response to a query sent to the database, and the scoring of the item can be based at least in part on a weighted average of one or more metrics.

In another aspect, the subject innovation can include a method of presenting personalized news content. The method can include the steps of connecting to one or more content providers over a network and receiving structured data associated with the news content from the one or more content providers. Additionally, the method can include the acts of updating a database based at least in part on the structured data received from the one or more content providers and downloading at least a portion of the news content to a content delivery network or one or more edge servers. The method can further include the step of selecting a next video from among the news content. The next video can be selected based at least in part on a weighted average of one or more metrics, and the one or more metrics can be calculated based at least in part on information stored in the updated database. Finally, the method can include a step of presenting the next video to a user.

In non-limiting embodiments disclosed herein, the innovation can include a method that can at least one of facilitate aggregation of news content from one or more sources or distribute the news content to individuals in a personalized manner. The manner of distribution can be self-learning and can also be suited to the unpredictable and/or dynamic nature of news coverage. In some embodiments, this method can at least one of utilize relatively minimal intervention on the part of the viewer or adapt to provide a dynamically-updated sequence of video news items tailored to viewer preferences.

In another non-limiting embodiment, the innovation can include a system capable of at least one of facilitating aggregation of news content from one or more sources or distributing the news content to individuals in a personalized manner. In other embodiments, the system can include one or more of: a centralized database, one or more download servers, a content delivery network (CDN) (or other suitable storage network), one or more web servers, or at least one client device.

In further non-limiting embodiments, the subject innovation can comprise one or more of computer-readable storage media that can store information or computer-readable instructions capable of at least one of facilitating aggregation of news content from one or more sources or distributing the news content to individuals in a personalized manner.

In some embodiments, a listing of content items can be retrieved from one or more content providers on at least one of a frequent or regular basis by the download servers. A record of one or more items in the list can be added to the database or can be updated if it has been changed from the previously-stored copy. The associated video can be one or more of downloaded, transcoded if necessary, or submitted for storage in the CDN or equivalent storage network.

One or more users of the service can subscribe by creating a unique account that includes some indication of their location or geography, such as a zip code (or postal code or other local geographic designation, etc., each of which is intended to be encompassed within the term zip code). Upon signing into the service from a web browser, mobile device, television, or other device capable of displaying network video streams, a query can be initiated against the collection of items relevant to the user's current geography. The items can be assigned a score based on a weighted average of a number of metrics representing user and/or community preferences. In some embodiments, the freshness of the item can also be a factor for consideration. The highest ranking content item can be returned. In some embodiments, a story can be represented by an item. In such embodiments, the highest ranking story can be returned. Playback of this item can then begin immediately in some embodiments. The user can have basic playback controls (e.g., one or more of fast forward, rewind, or pause, etc.) within the currently playing story. At any time, if the user determines the story is no longer of interest, the user can trigger a user interface element to signal that a new content item should be delivered. A record of the currently viewed item can be recorded along with the portion viewed, which can be used to update at least one of channel, item, or associated keyword statistics. The database then can be queried again for a new content item, and this process can continue until the user terminates the session or all available content items are exhausted. Periodically, pre-roll advertisements can be inserted before a story to generate a revenue stream from the use of the service. The advertisements can be targeted to individual user profile interests.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Various non-limiting embodiments are further described with reference to the accompanying drawings in which:

FIG. 1 is a block diagram illustrating a system and communication sequence facilitating a content retrieval process according to one embodiment of the subject innovation.

FIG. 2 is an entity relationship diagram for a database according to one embodiment of the subject innovation.

FIG. 3 is a flow diagram illustrating a communication sequence for a browser-based viewing session according to one embodiment of the subject innovation.

FIG. 4 is a user interface for a web browser viewing session according to one embodiment of the subject innovation.

FIG. 5 is a flow diagram illustrating a communication sequence for a typical viewing session from a mobile device, set-top-box, or other equipment accessing the service via a web services application programming interface (API) according to one embodiment of the subject innovation.

FIG. 6 is a block diagram of an exemplary networked or distributed computing environment in which embodiments described herein can be implemented.

FIG. 7 is a block diagram of a computing system environment in which one or more of the embodiments of the subject innovation can be implemented.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component,” “system,” “interface,” and the like, are generally intended to refer to a computer-related entity, either hardware, a combination of hardware and software, software, or software in execution. For example, a component can be, but is not limited to being, one or more of a process running on a processor, a processor, an object, an executable, a thread of execution, a program or a computer. By way of illustration, both an application running on a server or controller and the server or controller can be components. One or more components can reside within at least one of a process or thread of execution, and a component can be at least one of localized on one computer or distributed between two or more computers. As another example, an interface can include input/output (I/O) components as well as one or more of an associated processor, application or application programming interface (API) components, and a component, system, or interface can be as simple as a command line or as complex as an Integrated Development Environment (IDE). Also, these components can execute from one or more of various computer-readable media or computer-readable storage media having various data structures stored thereon.

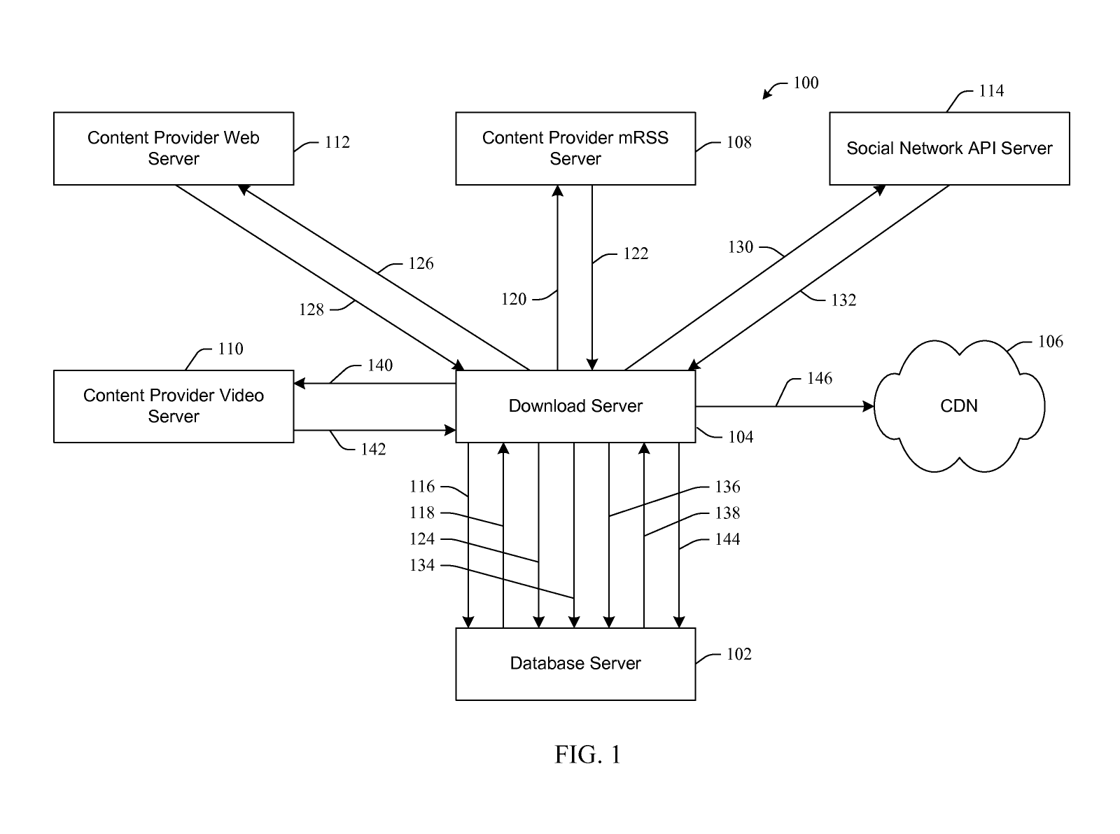

FIG. 1 is a block diagram illustrating a system 100 and communication sequence facilitating a content retrieval process according to one embodiment of the subject innovation. As shown in FIG. 1, the system 100 can include a number of interrelated components. In one embodiment, one or more of the components (or functions performed by the components) can reside on a single server, but in other embodiments, it is also possible that a single component can be distributed among multiple systems, for example, for one or more of scalability, redundancy, or performance. Although functional classifications are at times provided herein, the underlying infrastructure is flexible and may take the form of different embodiments. As shown in FIG. 1, the system 100 can include a database server 102. Database server 102 can house a database (e.g., a relational database, etc.), and can interact with one or more other components of the system 100. The database (e.g., relational database, etc.) of database server 102 can include one or more tables that can store data regarding at least one of various content provider channels, individual news items, item keyword tag information, item metadata word frequency, user submitted content, user and/or provider account data, etc., or interrelationships between one or more of the content provider channels, individual news items, item keyword tag information, item metadata word frequency, user submitted content, user account data and/or provider account data, etc. Additionally or alternatively, the database can further comprise at least one of stored procedures or functions for one or more of: adding and/or updating news items in the database, extracting word frequencies from item metadata, tracking user viewing patterns, or executing an algorithm to select the news item determined to be most relevant (e.g., as described herein, etc.) to a user at any given point in time.

The system 100 can further include one or more download servers, as represented by download server 104. The download servers (e.g., download server 104, etc.) can comprise one or more computer systems or components configured to connect to one or more content providers over a public or private data network to retrieve structured data regarding one or more of videos or stories, for example, one or more video news stories, which can include recently published video news stories. This structured data can be provided in any of a variety of formats. In some embodiments, this structured data can be provided in Media Really Simple Syndication (mRSS) format, though other formats, Extensible Markup Language (XML) or otherwise, could be equally suitable and can be used in other embodiments. At least one of channel or item metadata can be updated over time, for example, intermittently or frequently, at regular or varying intervals. In various embodiments, the frequency of updating can be static or dynamic. For example, the frequency of updating can be dynamic based on one or more factors, which can include server load, available bandwidth, time of day, or other factors in a production environment. In some embodiments, while the frequency can be dynamic or static, the frequency of updating can be typically no more than around 10 minutes. Information regarding new stories can be added to the appropriate table, and can be associated with (or with information indicative of) one or more of the following: a unique identification (id), an original media source, publication and/or expiration dates, or other data that can include, but is not limited to, at least one of content type, duration, language, title, description, or category. Keyword data can be one or more of parsed or recorded for one or more items if supplied, or can be programmatically determined if omitted by the content provider. Download servers such as download server 104 also can perform actions associated with one or more of retrieving video content, converting it, or saving it to a content delivery network (CDN) or other storage location. As described in further detail below with reference to FIG. 1 and the [keywords] table, keywords can be programmatically determined by looking at one or more of the item's title, description, or source page textual content, and identifying any words that exceed a minimum tf-idf (term frequency-inverse document frequency) score, as would be understood by a person of skill in the art in light of the discussion herein. Keywords need not be factored into a scoring algorithm such as those described below in embodiments wherein the content provider fails to provide any keywords and no keywords can be identified in the item's text-based metadata. In some embodiments, a part-of-speech analysis can be performed and can be utilized, for example, in embodiments wherein several content providers are covering a story. In many embodiments, content providers tag items with keywords that accurately describe the content both in broad and narrow scope (e.g., a broad keyword of “technology” and more narrow keywords of “social media” or “Blu-Ray”). In some embodiments, when multiple videos are associated with a story or multiple content providers are covering a story, keywords associated with one of the multiple videos or one of the videos of the multiple content providers can be associated with another, if appropriate (e.g., broad keywords, etc. of one video can be associated with a related video lacking keywords, etc.).

As shown in FIG. 1, the system can include a CDN 106. Downloaded content can be submitted for storage within a CDN such as CDN 106. In various embodiments, performance can be improved or optimized by distributing video content to various edge servers. In such embodiments, one or more of the edge servers can be variously geographically located throughout the world so as to minimize the number of hops or latency between a requesting client and the edge server. For example, a client in California could retrieve video from an edge server in California or perhaps a neighboring state, while a client in Chicago could retrieve video from an edge server in Chicago, etc.

In some embodiments, the CDN 106 can have at least one of the structure or functionality of CDNs of one or more entities that manage or manufacture CDNs, for example, the CDN manufactured by Akamai Technologies or the like. In some embodiments, storage space can be leased on a CDN, for example, the CDN manufactured by Akamai Technologies or the like. The CDN manufactured by Akamai Technologies is listed as one example CDN, and in aspects, the subject innovation can utilize at least one of any number of other CDNs or storage space on any number of other CDNs for storage, as described herein. Further, while some embodiments described herein and shown in the figures refer to a “CDN” (e.g., CDN 106, etc.), in various embodiments, a CDN is not required and can be replaced with most any type of suitable storage. For example, in some embodiments, in lieu of using a CDN, local storage on one or more web servers described herein can be used. Other storage scenarios are also possible, including, but not limited to, storage utilizing a network-attached storage (NAS) device or a storage area network (SAN), etc.

In some embodiments, video storage can be distributed between centralized storage and edge servers. For example, in one non-limiting embodiment, stored video can be retrieved from centralized storage on a first request and cached for a period of time. In another non-limiting embodiment, stored video can be retrieved on every request (as opposed to being retrieved on a first request and cached). The manner of at least one of video storage or retrieval of stored video can comprise any of a number of different approaches, and the embodiments of the innovation described herein are not limited to any specific video storage architecture nor any method or approaches to retrieving stored video.

In aspects, system 100 can include one or more web servers. In some embodiments, the one or more web servers can include the Content Provider mRSS Server 108 shown in FIG. 1. In other embodiments, other types of suitable web servers can be employed. The one or more web servers can host one or more interfaces for viewing content. The one or more web servers can also at least one of: facilitate initial account sign-up, offer an interface to content providers to interact with a service as described herein, or house a web service application programming interface (API) to allow for other devices to interact directly with the database server without requiring browser-based access.

In various embodiments, one or more of an optional Content Provider video server 110, an optional content provider web server 112, or the content provider mRSS server 108 can be operated by the content provider. One or more social network API servers may be provided by the operators of those networks, as represented by social network API server 114. As such, while the social network API server 114, content provider video server 110, web server 112, and mRSS server 108 are shown in FIG. 1, in various embodiments, not all of these components need be included, and in some embodiments any or all of these components may be external to a system of the subject innovation, and may, for example, be provided by third-parties. Some embodiments described herein can utilize HTTP protocol access to one or more of the mRSS feed provided by the mRSS server 108, source page full text, social network APIs on social network API server 114, or video files on the Content Provider video server 110, though in other embodiments, other protocols such as RTMP may be utilized. Although reference herein is frequently made to HTTP protocol, such reference is intended to encompass other protocols (e.g., RTMP, etc.). While shown as different entities in FIG. 1, one or more of the Content Provider video server 110, web server 112, social network API server 114, or mRSS server 108 could be, in different embodiments, provided by a single web host. Alternately, at least one of the mRSS feed or source page content could reside within a hosted content-management system while the videos could be hosted on a CDN server owned and/or operated by the CDN 106.

Users can view content from a service in accordance with aspects of the innovation on a variety of platforms or user devices, which can include, but are not limited to, a personal computer with web browser, an Internet-connected mobile device, or a television via a set-top box, integrated software, or other device with network connectivity.

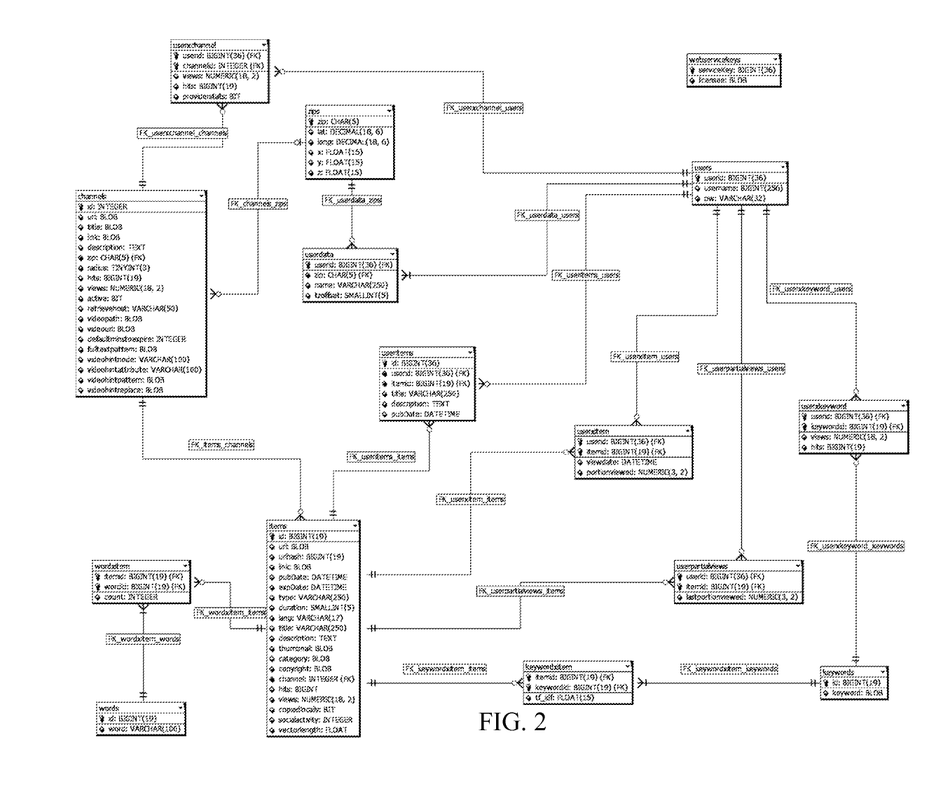

One embodiment of the database design will now be described with reference to FIGS. 1 and 2. Turning first to FIG. 2, FIG. 2 illustrates one embodiment of an entity relationship diagram for a database in accordance with aspects of the subject innovation. The diagram of FIG. 2 is shown in “crow's foot” notation for one possible database implementation that could exist on a database server such as database server 102 to support embodiments described herein. It can include the following tables, which can be stored on computer-readable storage medium in some embodiments:

[users] —The [users] table can contain one or more of a unique user identifier, a username (e.g., an e-mail address, etc.), or some representation of the user's password. While shown in FIG. 2 as a plain-text field, in various embodiments, one or more of password hashes, encryption, or other techniques to secure the passwords or avoid storing them directly could be employed and stored in the table. In one example, the password can be stored in a separate supporting table.

[channels]—The [channels] table can include details about one or more content provider feeds. One record can be stored for one or more mRSS feeds or other feeds utilizing another standard providing comparable data elements. In other embodiments, these can utilize at least one of proprietary XML formats, delimited or fixed-width text files, serialized structures stored in a binary file, or other formats, including those yet to be defined. As an illustrative example, another possible format that can be employed can be a format that extends RSS in a similar manner as mRSS (e.g., the Apple Computer ITUNES® software). While RSS is one exemplary format, ITUNES® software format parsing or other format parsing can also be used to provide improved compatibility.

In addition to a unique channel identifier, one or more of the URL for the feed, title, website, description, content provider zip code (for local providers), radius of relevance, number of hits on videos from the channel, cumulative number of complete stories watched, an active/inactive flag, the download server to which the feed is assigned, a storage path for retrieved videos, the public base universal resource locator (URL) to access videos from this channel, the default validity period for any items retrieved that do not have an explicit expiration set can be stored, a regular expression defining the area of an item's source page containing the full text for the story, nodes and/or attributes for inferring a video file's URL from story metadata in the feed, or regular expression find and replace patterns that define the location of an item's video file based on story metadata in the feed.

[items] —The [items] table can store a record for one or more video stories known to or accessible by the system. One or more stories can have at least one of a unique item identifier, a URL for a media file, a hash of the URL for the media file (to allow for a key to be created to ensure URL uniqueness), a link to the content provider's representation of the story, the publication date, an explicit or calculated expiration date, Multipurpose Internet Mail Extensions (MIME) content type, duration (e.g., in seconds, minutes, hours or any other suitable unit of time), language code, title, description, thumbnail (e.g., content provider thumbnail, system-generated thumbnail, etc.), category, copyright notice, source channel, a value for the number of hits accumulated for the video, a value representing total cumulative views (e.g., the total cumulative views could be represented by the total seconds watched by all users divided by the duration, etc.), an indicator that the video has been retrieved and/or processed by the download service, an aggregate count of social network activity related to the story's link, or the tf-idf vector norm for the item's keywords. As used herein, the term “download service” can refer to the downloading functions (e.g., those described with reference to FIG. 1, the other systems and methods disclosed herein that describe downloading operations, or other functions as would be apparent to a person of skill in the art in light of the teachings herein).

The [keywords] table can include keywords or key phrases found or identified. The keywords or key phrases can be assigned to a download item and have an entry in the table. In some embodiments, a unique keyword identifier can accompany each keyword or key phrase.

The [words] table can include words that have been programmatically identified within one or more of an item's title, description, or source page textual content. The words can be assigned to a download item and can have an entry in the table. In some embodiments, a unique word identifier can accompany each word.

The [zips] table can be a data table storing zip code, latitude, longitude, and/or pre-calculated values to make distance calculations efficient. The pre-calculated values can include those utilized for calculating “great circle” distances on a sphere. For example, the formula for calculating a great circle distance on a sphere involves the multiplication and addition of values that are always constant for any point on the sphere. Therefore, by storing these constant, pre-calculated values for every zip code (represented by x, y, and z) instead of calculating the constant values every time a great circle distance is to be determined in an SQL query, efficiency can be greatly improved. This approach is sometimes utilized in radial search applications.

The [userdata] table can store demographic data about the user (or users), including, but not limited to, one or more of the following for each user: their zip code, their name (for user-submitted items), or the time zone offset on the most recent device used to access the service.

The [useritems] table can store details about videos uploaded by users of the service. One or more records can have its own unique identifier and may optionally include fields recording one or more of the user that uploaded the video, the story to which this footage is related, a title and/or description for the uploaded footage, or at least one of the date and time it was uploaded.

The [userpartialviews] table can store one or more of the user ID, item ID, or a portion viewed for videos that are presented to the viewer but which have not completed playback or been skipped by the viewer. These videos can be presented again to the viewer to allow them to complete the viewing, and this table can, in some embodiments, ensure that the previously viewed portion can be counted in the statistics. In some embodiments in which the CDN 106 provides streaming support, the table information can also be used to resume playback near where the video stopped in a previous viewing session.

The [keywordxitem] table can be an associative table that records which keywords are tagged on one or more story items. In some embodiments, the tf-idf score for the keyword-to-item pair can be at least one of stored in this table or updated while the item is listed in the feed for the channel, which can occur each time the feed is polled for new content. This can reduce the computational cost of running the [GetNextStory] function described herein.

The [wordxitem] table can be an associative table that can record which words have appeared in one or more story items. In some embodiments, a word count for each word-to-item pair that is used in calculating tf-idf scores can be stored.

The [userxchannel] table can be an associative table. For one or more user and channel pairs, this table can store at least one of the number of cumulative full video views, the total number of video hits, or whether or not the user represents the content provider for that channel and therefore can access the content provider portal.

The [userxitem] table can be an associative table with a record for one or more videos watched in its entirety or skipped by the viewer. In some embodiments, the record for every video watched in its entirety or skipped by the viewer can be stored. At least one of a date and time when this event occurred (e.g., watching in entirety or skipping) or the portion viewed can also be saved.

The [userxkeyword] table can be another associative table used to store statistics about the user's keyword interests. For one or more keyword and user pairs, the cumulative total views and/or hits can be stored for all items viewed by the user that were tagged with the keyword.

The [webservicekeys] table can be a repository of one or more issued and/or valid license keys for the web service API. In some embodiments, the table can be a repository of all issued and/or valid license keys for the web service API.

Referring to FIGS. 1 and 2, a content retrieval process according to one embodiment is described. The content retrieval process can include one or more of aggregating story metadata into a common database or downloading the associated video from content providers for storage within the CDN, in one embodiment. In other embodiments, one or more steps of the process can be omitted or combined with another step.

While, for purposes of simplicity of explanation, the one or more methodologies shown herein, e.g., in the form of a flow chart or diagram, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Turning to FIG. 1, one method of content retrieval can be as follows. As shown at 116, at intervals (e.g., predefined intervals such as every 10 minutes or at other time periods, at dynamic intervals, etc.), the download server 104 can query the [channels] table in the database for all feeds that are both listed as active and are allocated to it. At 118, the database server 102 can return a result set with zero or more rows indicating channels that the requesting download server 104 should download. At 120, the download server 104 can launch separate threads of execution for one or more feeds to be downloaded. The number of simultaneous threads can be limited by system resources or available bandwidth. One or more threads can submit a Hypertext Transfer Protocol (HTTP) request (or request using another protocol, as described herein) for the URL of the mRSS feed to the content provider's web server 112.

At 122, the Content Provider mRSS server 108 can return a HTTP response. If this response has a predetermined value (e.g., 200 (OK) response), the mRSS feed content can follow with applicable headers and can be stored in memory by the download server 104 for parsing. Otherwise, the thread can exit and no further processing need occur for this channel until the interval elapses, at which time a new request can be generated.

At 124, the download server 104 can process the XML nodes within the returned document. As it does so, it can update the associated record in the [channel] table to include one or more of the channel's updated title, description, or website link. It then can process one or more items in the document.

If a regular expression for extracting the full text for the story is defined for the channel, the download server 104 can issue an HTTP request to the link URL at 126, and can parse the response sent at 128 according to the regular expression.

At 130, the download server may optionally request a current count of global social networking events for the item's URL from at least one of various social network platforms through their respective application programming interfaces. Any responses sent at 132 may be aggregated using a simple sum or other suitable formula into at least one numeric indicator of the level of social network activity surrounding the item.

At 134, the download server 104 can then submit at least one of the source channel's ID, media file's URL, the content provider's associated page for the item, or the publication date to an [InsertItem] stored procedure within the database. Optionally, it can also include one or more of an expiration date, content type, duration, language, title, description, thumbnail image, content category, copyright information, a comma-separated listing of keywords, retrieved story text from the source page, or a social network activity score (in accordance with various embodiments described herein).

In some embodiments, the steps for the [InsertItem] procedure can be as follows. The [InsertItem] procedure can begin by calculating an expiration date for the submitted item. If no explicit date and time were defined, the item can be set to expire after a default number of minutes (which can be any positive real number of minutes) defined on the channel in the [channels] table. The explicit or default expiration can be then evaluated to ensure it is no more than a specified time period (e.g., one week, or any other time period, etc.) from the publication date. If it is, the expiration can be set to the specified time period (e.g., one week, etc.) from the publication date. Next, the procedure can check a hash value (e.g., the SHA-1 hash value, etc.) of the URL of the media file and compare this against previously stored hash values to see if the item already exists in the database. If no item exists and the item hasn't already expired, it can be added to the database. Otherwise, the existing item can be updated regardless of the calculated expiration date. If explicit keywords were defined by the content provider, this list can be parsed. When a keyword is a single word, a stemming or similar algorithm (e.g., a Porter stemming algorithm, etc.) can be applied to reduce the word to a representation of the word in its most basic form (e.g., a stem, etc.). One or more keywords can be added (e.g., in a most basic form, etc.) to a master [keywords] table if they do not already exist. The identifier for each new or existing keyword can be retrieved. Entries can then be added to the [keywordxitem] table to indicate the presence of one or more keywords on the item being added or updated if they do not already exist. As an actual tf-idf score cannot be suitably calculated for these keywords, a static or dynamic predefined value can be used. In some embodiments, this value is 0.25, although greater or lesser values can be used. The procedure can then submit text comprising at least one of the title, description, or full-text information passed to it to a [WordList] function that can parse the text based on word boundaries, and can apply the Porter stemming algorithm (or other algorithm) to each word and can return a list of words and their associated counts. Each word's tf-idf score can be computed and compared with a threshold value. In some embodiments, this threshold can be 0.12, although other values, greater or lesser, can be used. As with the content provider's keywords, one or more keywords can be added to a master [keywords] table if they do not already exist. The identifier for each new or existing keyword can be retrieved. Entries can then be added to the [keywordxitem] table to indicate the presence of one or more keywords on the item being added or updated if they do not already exist. The calculated tf-idf score can be added or updated for each keyword-to-item pair. Entries that are no longer valid for the item—for example, in cases where a content provider has revised the list of keywords and/or removed one or more keywords, or in cases where the updated tf-idf score no longer qualifies a word as a keyword, etc.—can be removed. When all keywords have been processed, the system can determine a norm for the item. For example, the system can compute the L² (Euclidean) vector norm as the square root of the sum of the squares for all keyword tf-idf scores and stores this value in the [items] table to facilitate the calculation of item similarity. Additionally or alternatively, other norms can be used, such as other L^{p} norms, etc.

At 136, a separate thread can run continuously on the download server 104. It can query the [items] table for the oldest item for which no video has yet been downloaded.

At 138, the database server 102 can return a single row for the oldest item that still needs to be downloaded. If no items require downloading, an empty result set can be returned and the thread can sleep for a period of time (e.g., it can sleep for the same interval defined for the mRSS requests, etc.).

At 140, an HTTP request for the item's media URL can be sent to the content provider's video server 110 to initiate download.

At 142, the content provider's video server 110 can return an HTTP response to the download server 104. If this is an HTTP “200” (OK) response (or other suitable response), the video file's content can follow and can be retrieved to a local temporary folder with a filename that can be set by the system, for example, based on an SHA-1 or other hash of the media URL.

At 144, if the video server 110 did not serve the requested video file, the item can be removed from the [items] table entirely (or, in other embodiments, the item can be temporarily skipped, a record can be made or updated of the number of times the item was skipped, and the item can be removed when this number reaches a threshold (e.g., 2, etc.), so as to avoid removing items that may only be temporarily unavailable, etc.). Related records in other tables can also be removed upon removal of the item. This can result in the item being added again with a new ID number if it still exists in the mRSS file on the next pass, effectively moving it to the end of the download queue. If the video was removed unexpectedly by the content provider, it can also be removed from the feed, and deleting it from the database can be an appropriate action.

If the file was downloaded completely, it can be transcoded locally before transmission to the CDN 106. In one embodiment, the format can be MP4 with H.264 video and/or Advanced Audio Coding (AAC) audio streams, although any other formats for encoding at least one of video and audio may be used in other embodiments. If the file is in the selected (e.g., MP4, etc.) format, it can simply be analyzed for duration and/or thumbnail extraction. Otherwise, it can be converted into the selected format (e.g., MP4, etc.) using codecs such as those mentioned previously, optionally with at least one of duration analysis or thumbnail extraction performed as part of the conversion process. If the conversion or analysis fails, the item's record can be deleted from the [items] table, which, as mentioned previously, has the net result of moving it to the end of the download queue. Otherwise, the record in the [items] table can be updated with the analyzed duration and/or a bit field can be modified to indicate that the file was successfully retrieved from the content provider.

At 146, a CDN such as CDN 106 can be used to serve the videos, then the transcoded file can be uploaded to the network in this step using File Transfer Protocol (FTP), HTTP, a proprietary API, or other means. It can be desirable to have the CDN 106 transcode the video if the service is available. Although not shown in FIG. 1, an additional flag can also be updated on the item record when the video is available on the CDN 106.

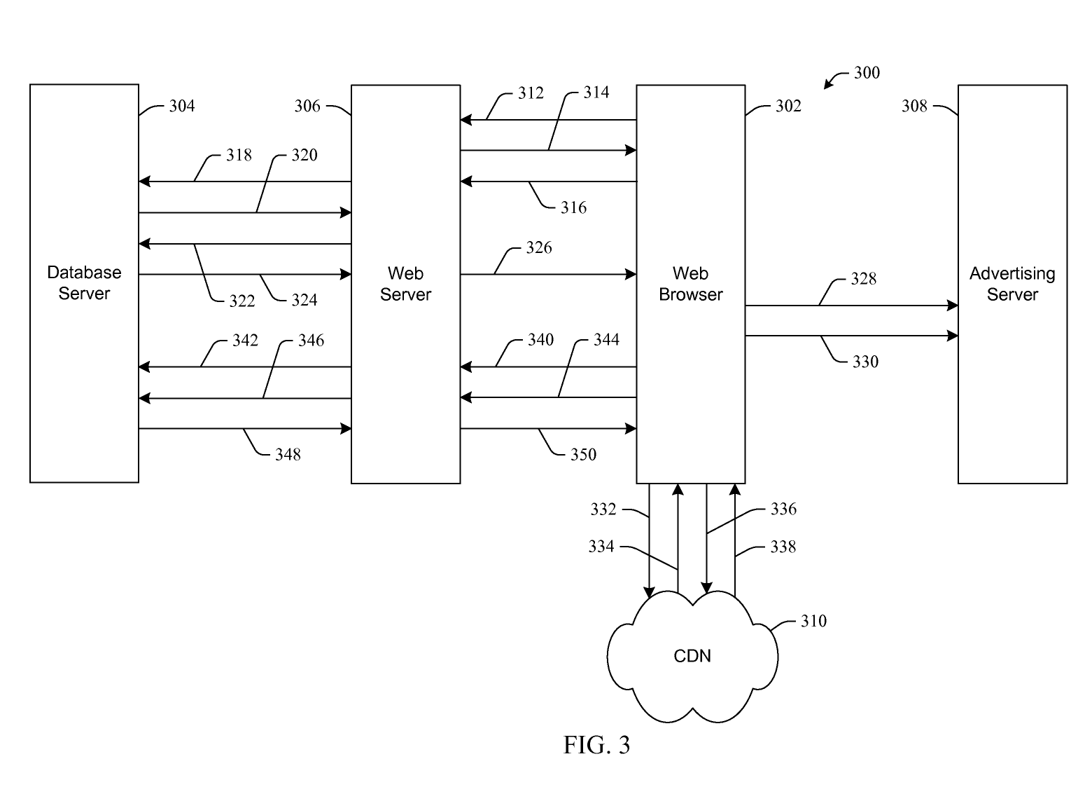

FIG. 3 is a flow diagram illustrating a communication sequence in connection with a system 300 for a browser-based viewing session according to one embodiment. The viewing session can be facilitated by a web client in some embodiments. Users can interact with the system described above from a number of different platforms. One possible interface to the service is through a web browser such as web browser 302.

FIG. 3 illustrates one embodiment of information flow between various servers and a web browser 302 to facilitate a client viewing experience. As such, FIG. 3 illustrates yet one more embodiment of a system disclosed herein. As shown, the system can include one or more of a database server 304, a web server 306, a web browser 302, an advertising server 308, or a CDN 310. The database server 304 and web server 306 can be as described with reference to FIG. 1, although they can also be wholly or partially different in structure and functionality. One example embodiment of a process utilizing the components of the system 300 of FIG. 3 is as follows. Further, while the steps are shown and described with reference to FIG. 3, in other embodiments, one or more steps of the process can be omitted or combined with another step.

At 312, the web browser 302 can send an HTTP request to the web server 306 for the login page. At 314, the web server 306 can send an HTTP response with the login page. At 316, the user can enter their username and password credentials into the web form and can post the response back to the web server 306. At 318, the web server 306 can contact the database server 304 to validate the user's credentials against the [users] table or equivalent.

At 320, the database server 304 can respond to the query in step 318. If the credentials are valid, flow can continue with step 322. Otherwise, flow can continue with step 314, and an error message can be included in the response.

At 322, the web server 306 can prepare to serve the default viewing interface. Before sending the response to the client, the web server 306 can contact the database server 304 and call the [GetNextStory] function, which can include passing the user's internal ID to the procedure.

At 324, the response from the database server 304 can contain one or more details for populating dynamic areas of the viewer interface. In some embodiments, all necessary details can be contained in the database server 304 for populating dynamic areas of the view interface. The page can be prepared in memory on the web server 306 using this response data. If no record is returned, the dynamic areas can be left blank or filled with other material or information, such as default content, advertisements, etc.

Because the systems, methods, and services described herein can build a detailed interest profile showing the relative level of interest in various topics, it is possible to offer targeted advertising based on this information. In some embodiments, for example, wherein the player supports a dynamic configuration profile, advertising zones can change based on the story about to be displayed as well. Additionally, since the user can enter their zip code or other location information (e.g., a home or work address, an IP address, etc.) to subscribe to the service, regional advertising can be provided in some embodiments. If a targeted zone is used to deliver advertisements, this targeted zone can be returned as part of the database response and passed to the client.

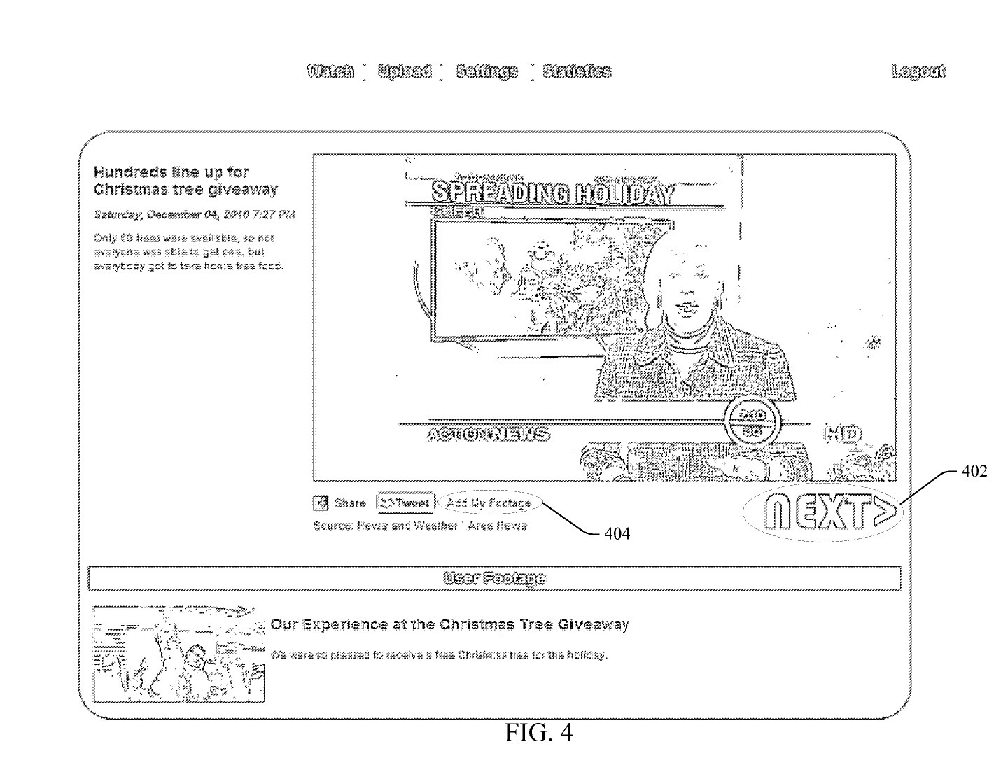

At 326, the web server 306 can respond with a page containing the main viewer interface. This interface can include one or more of the following: a region for a video player window utilizing Adobe Flash, HTML5 video, or an equivalent; a button configured to cause the current video to be bypassed upon activation (e.g., a Next, Skip, or similar button, etc.); story details such as title, publication date, description, source, and/or a link to the original story on the content provider's website; social networking components to allow the content to be shared with others; or an area for user-submitted content related to the story. In some embodiments, one or both of the first two items—the player region or a user interface control for advancing to the next story—are needed for the service to operate properly, and other items need not be included. If present on the page, at least one of story details or social networking user interface (UI) controls can be pre-populated as part of step 322. Example social networking UI controls are discussed in further detail with reference to FIG. 4 below.

Turning back to step 326, using JavaScript or another comparable client-side scripting technology, the player can be instantiated within the client window. As part of this process, callbacks can be wired up for events related to one or more of the progression of the video or the completion of playback. This also can include appropriate configuration for the advertising server 308.

At 328, the player can send a request to the advertising server 308 for a pre-roll video advertisement.

At 330, the advertising server 308 can send a structured response to the client (e.g., in a video ad serving template (VAST)-compliant or similar format) that can identify one or more of the advertisement about to play, any tracking information, the destination page for a user click, etc.

At 332, the player can send a request to the CDN 310 for the advertisement. While only one CDN 310 is shown in the illustration, multiple CDNs can be employed for at least one of video advertising or for story content delivery.

At 334, the CDN 310 can begin providing streaming data to the client, which can be decoded by the player and displayed to the viewer as a pre-roll advertisement. At least one of passive viewing or active interaction with the advertisement can generate additional requests at this point in some embodiments.

At 336, on completion of the advertisement, client-side script can update the player's playlist with the story's media file URL. A new request can be then sent to the CDN for this content.

At 338, the CDN 310 can begin to send streaming data to the client for decoding and presentation.

At 340, playback can be monitored in the client-side callbacks. An Asynchronous Javascript and XML (AJAX) (or similar) request can be transmitted to the web server 306 when at least one or more of the following events occur: one or more quartile markers are crossed, the video is paused, or the browser is closed. In some embodiments, no new information need be returned.

At 342, in response to step 340, one or more of the user's ID, currently playing item, or current playback position can be stored in the database's [userpartialviews] table by the web server. This can be done so that it can be possible to resume playback near where a user left off if they simply closed the browser during playback (either intentionally or not) and returned to the same story later, and can additionally ensure that a good approximation of the actual portion viewed can be stored if the user skips the video in a later session.

At 344, playback can continue until the user clicks the Next button or the video reaches completion and the appropriate callback is fired. One or more of these events can trigger a new AJAX, etc. request to the web server 306. This request can include information stored in hidden fields, such as the currently playing item ID, the portion that has been viewed, etc.

At 346, the web server 306 can call the [UpdateUserView] stored procedure on the database server 304, which can update one or more of item, global channel, or user-specific channel and/or keyword statistics in the [items], [channels], [userxchannel], and/or [userxkeyword] tables, respectively, based on the portion viewed. It can also add a record indicating one or more of that the item was viewed or the portion viewed in [userxitem]. The web server can then call the [GetNextStory] function to retrieve the next story, now that all statistics have been updated.

At 348, the database server can return the results of [GetNextStory].

At 350, a response can be returned to the browser 302. The response can update at least one of the media file URL, item ID fields, and any or all dynamic regions on the page (e.g, title, description, publication date, user-submitted items, social networking buttons, and/or the like).

In various embodiments, playback can continue until the user closes the session or there are no unwatched videos of relevance in the system. Requests 334 through 350 can be repeated for one or more new stories played. Periodically, requests 338 through 350 can be sent instead to display a new advertisement to the viewer, which can be triggered as playbacks are monitored by at least one of the client or web server 306.

FIG. 4 is a user interface displaying example content during a web browser viewing session according to one embodiment. As shown in FIG. 4, in various embodiments, social networking UI controls can include buttons (or portions of the UI that can be activated, etc.) that allow the user to distribute a link to social network connections that the user has made in various social networks. For instance, as shown in FIG. 4, a Facebook SHARE® button can allow the user to make a link to the story appear in the news feed of the user's friend on Facebook, a Twitter TWEET® button can allow the user to add a quick link to the story as an update on the user's Twitter feed, etc. In other embodiments, other social network UI controls can also be employed, generally, for distributing information to social network connections.

As also shown in FIG. 4, a Next button 402 is also displayed, as indicated by the dashed area. The Next button 402 (or equivalents) can be configured to enable the end user to provide feedback to the algorithm. In some embodiments, for example, clicking or not clicking (or otherwise activating or not activating the Next button 402 or another predefined portion of the UI) can send information that can at least one of: provide the systems described herein an implicit or explicit indication of the user's level of interest in the content displayed, update the statistics that drive one or more of the metrics in algorithms discussed herein, or advances to the next story.

Also shown in FIG. 4 is an optional User Footage section at the bottom of the UI. The User Footage section shown in FIG. 4 displays one possible layout in which user-submitted content can be listed alongside the main story for other viewers. This section allows for the user community to participate in the news generation process, and can be configured or presented in substantially any manner, including those different from that shown in the non-limiting example of FIG. 4.

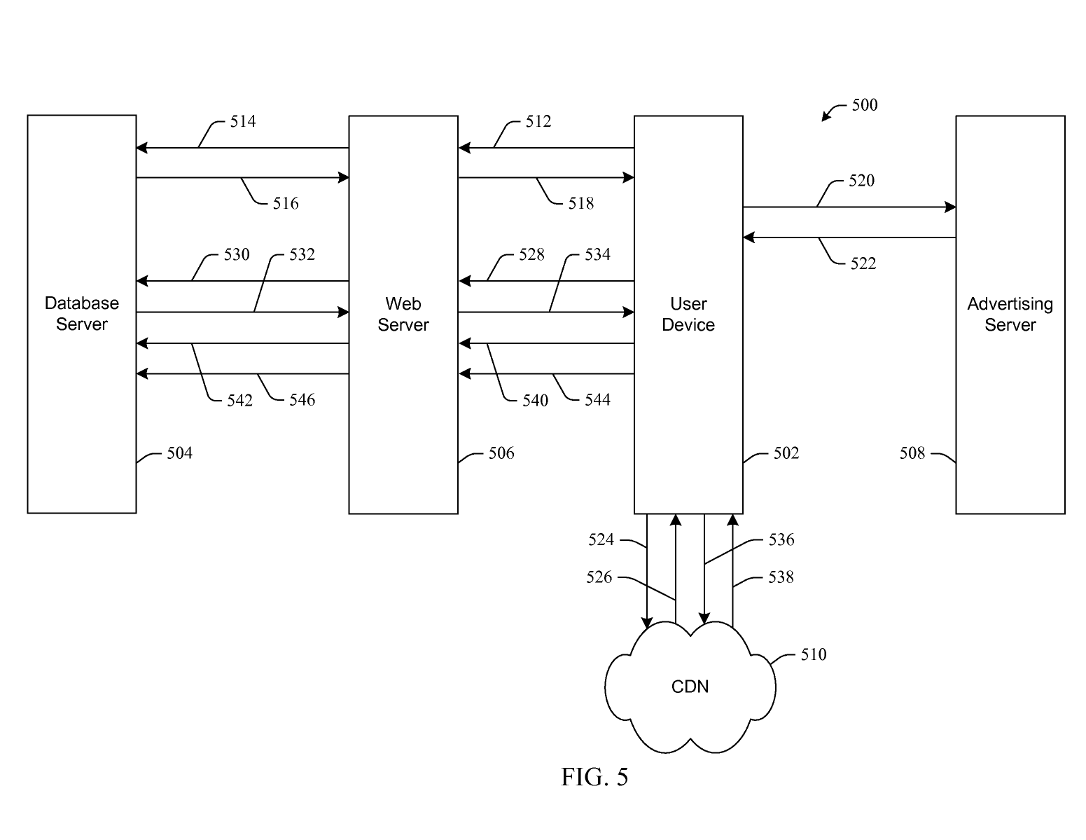

FIG. 5 is a flow diagram illustrating a communication sequence for a typical viewing session from a user device 502 (e.g., mobile device, set-top box, or other equipment (e.g., integrated television software application) accessing the service via a web services API, etc.) according to one embodiment. As described further herein, user device 502 can interact with other portions of system 500, which can include one or more of a database server 504, web server 506, advertising server 508, or CDN 510.

FIG. 5 illustrates another system and embodiment of information flow for interaction with the service through various user devices. As such, FIG. 5 illustrates yet one more embodiment of a system disclosed herein. As shown, the system 500 can include at least one of a database server 504, a web server 506, user device 502 (which can be, for example, a mobile device or set-top box, etc.) an advertising server 508, or a CDN 510. One or more of database server 504, web server 506, advertising server 508, or CDN 510 can be as described with reference to FIG. 1 or 3, or can be partially or entirely different in structure and functionality. One example embodiment of a process utilizing the components of the system 500 of FIG. 5 is as follows. Further, while the steps are shown and described with reference to FIG. 5, on other embodiments, one or more steps of the process can be omitted or combined with another step.

In the system of FIG. 5, the same or similar functionality available through the web client discussed in connection with FIG. 3 can also be exposed to these devices through a web services API model. The process can be somewhat similar to the web client approach, but responsibility for presentation can lie with the codebase on the client device. The communication steps representing the flow of information in one possible embodiment are diagrammed in FIG. 5.

At 512, the client device (e.g., user device 502, etc.) can send a secured secure socket layer (SSL) simple object access protocol (SOAP) request (or a similar request) to call an authenticate method on the web server. It can pass in the user's authentication credentials and may optionally include a header with a service key for the licensee that can be application-specific. This can help to prevent abuse of the service.

At 514, the web server 506 can contact the database server 504 to validate the submitted credentials in [users] or equivalent and optionally the service key in [webservicekeys].

At 516, the database can return results to the queries in step 514.

At 518, if the credentials, and optionally the service key, are valid, the web server 506 can create a unique temporary authorization token, cache it locally for a reasonable viewing period (two hours, for instance, although greater or lesser periods of time may be used) and send this to the client. This token can be submitted in the header information on one or more subsequent requests so that, in some embodiments, credentials only need to be validated once per session. Otherwise, an error message may be returned at this step, after which the client would need to take corrective action, such as resuming from step 512 or gracefully terminating.

At 520, before playback of the first item, the client device 502 can submit a request to the advertising server 508 for a pre-roll video advertisement.

At 522, the advertising server 508 can send a structured response to the client device 502 (in a VAST-compliant or similar format) that can identify one or more of the ad about to play, any tracking information, the destination URL on a user request for more information, etc.

At 524, the client device 502 can send a request to the CDN 510 for the advertisement. While only one CDN 510 is shown in the illustration, multiple CDNs can be employed for video advertising and/or for story content delivery.

At 526, the CDN 510 can begin providing streaming data to the client device 502, which can be decoded using local codecs and displayed to the viewer as a pre-roll advertisement. At least one of passive viewing or active interaction with the advertisement can generate additional requests at this point based on the device type.

At 528, on completion of the advertisement, the client device 502 can send a request to the web server to call the [GetNextStory] method with no parameters. The authorization token obtained in step 518 can be sent in the header.

At 530, the web server 506 can contact the database server 504, which can run the [GetNextStory] function, which can include passing in the user ID associated with the authorization token.

At 532, if an unwatched story is available, the web server 506 can return details in the result set.

At 534, the web server 506 can respond to the call of client device 502 to the [GetNextStory] method with all of the columns present in the result set. If no stories are available, an empty response can be sent and the client device 502 can act accordingly, either terminating or waiting for a predefined period for a new story to possibly arrive, at which time flow could resume with step 528.

At 536, a new request can be then sent to the CDN 510 for the media file's URL.

At 538, the CDN 510 can begin to send streaming data to the client device 502 for decoding and presentation.

At 540, playback can be monitored by events in the client's player control. As one or more of portions of the video (e.g., quartile markers, etc.) are crossed, the video is paused, or the user closes the application, the client device can call the [UpdateLastViewed] method on the web server 506 with the item ID and portion viewed, submitting the authorization token in the header.

At 542, in response to step 540, at least one of the user's ID, currently playing item, and current playback position can be stored in the database's [userpartialviews] table by the web server. This can be done so that it can be possible to resume playback near where a user left off if they simply closed the session during playback (intentionally or not) and returned to the same story later, and can additionally ensure that a good approximation of the actual portion viewed can be stored if the user skips the video in a later session.

At 544, playback can continue until the video completes or the user initiates a request to skip the video. As examples, on a mobile platform, this might simply be a tap or swipe gesture. For television viewing, this could be a button press on a remote. Either event can trigger a call to the [UpdateUserView] method on the web server 506. Like the call to [UpdateLastViewed], this can include one or more of the item ID, portion viewed, or the temporary authorization token in the header.

At 546, the web server 506 can call the [UpdateUserView] stored procedure on the database server, which can update at least one of item, global channel, or user-specific channel and/or keyword statistics in the [items], [channels], [userxchannel], and/or [userxkeyword] tables, respectively, based on the portion viewed. It can also add a record that can indicate either or both of that the item was viewed or the portion viewed in [userxitem].

Playback can continue until the user closes the session or there are no unwatched videos of relevance in the system. Steps 528 through 546 can be called to retrieve one or more new stories for playback. Periodically (e.g., at static or dynamic intervals, etc.), steps 520 through 546 can be executed to include a video advertisement before the next story plays. The playback frequency for advertising can be coded into the client device 502 in this embodiment.

A scoring algorithm can determine, at any given point in time, which video would be most appropriate to serve to the viewer next. The scoring and/or subsequent determination or content provisioning can be facilitated through the use of the ([GetNextStory]) function described herein, and, in some embodiments, with functionality related to the operations of FIG. 1 generally. The description that follows relates to functions described in connection with various aspects of the subject innovation, such as those of FIGS. 3 and 5.

In some embodiments, the scoring algorithm can be implemented as a user-defined function on a database server as described herein. The parameter passed to the function can include a user ID. In some embodiments, user ID can be the only parameter passed to the function.

The function can return one or more of the following related to the highest scoring item: the item's ID, media URL, the content provider's URL for the story, the publication date, the expiration date (e.g., as calculated by the [InsertItem] procedure, etc.), duration (e.g., length of the video in some unit of time), language, title, description (e.g., the returned item's description, such as a summary of the story's complete, or in some embodiments, incomplete, content in human-readable text, etc.), content provider's thumbnail (or a generated thumbnail, etc.), content category, copyright notice, the previous portion viewed if the item was partially viewed previously, the associated channel's ID, channel title, channel's website, channel description, channel location information (e.g., zip code, etc.) (if the channel serves a local market only), or a calculated score.

In some embodiments, the description can be the same as in the database description provided above. In some embodiments, the fields prefaced with “channel” (e.g., channel description, channel title, channel zip code, channel's ID) can be retrieved from the [channel] table and all other fields can be retrieved from the [items] table (each described above).

In some embodiments, the duration can be described to provide an appropriate level of granularity. The level of granularity that is appropriate can depend on the type of the content. In embodiments described herein that include news content, duration can be provided in seconds to provide a suitable level of granularity (e.g., in determining or recording a portion viewed, for example, for calculating a number of viewings or determining a portion with which to resume playback, etc.).

In some embodiments, the channel's website can be stored internally as [link] for naming consistency with the RSS specification. In some embodiments, however, this field can represent the channel's website URL.

The [GetNextStory] function can return the results of a single SQL query. The results can contain either one row or no rows. One column in the result set can be a relevancy score. The relevancy score can be calculated, for example, as a weighted average score, such as by adding together the scores for one or more of the individual metrics mentioned in the following paragraphs, each multiplied by their individual weights, and dividing by the sum of the individual weights. This calculation can provide a weighted average score. The formula in the query used for calculating the relevancy score can contain a number of subqueries containing Structured Query Language (SQL) (although specific reference is made to SQL, use of this term is intended to encompass other relational database queries, query formats or languages, etc.) aggregate functions (like SUM( ) or COUNT( ) and a WHERE clause that can provide the appropriate filters for the statistic being requested at that point in the formula, in some embodiments, in order to obtain values to perform the calculation. Additionally, in some embodiments, the function can first populate a series of scalar and table variables to replace one or more subqueries in order to improve performance and/or reduce the overall computational cost. In such embodiments, table variables can be referenced as joins in the final query, and scalar variables can be referenced directly, to allow for the calculation of the relevancy score from this data.

The calculated score can be calculated for all national items and/or local items that are within a certain radius (e.g., within a 75 mile radius or other suitable radius as defined for the channel) of the viewer, have been downloaded and/or added to the CDN successfully, and have not yet expired. The calculated score can be derived from metrics described herein that can include a base score ranging from 0 to 1 and an optional weighting multiplier. Additionally, although specific ranges (e.g., of a score ranging from 0 to 1, etc.) are discussed herein, it is to be appreciated that these ranges may be mapped to substantially any other range (e.g., via a linear or nonlinear mapping to a range from x to y, where x and y are real numbers, etc.), and although reference is made to specific ranges herein, embodiments with other ranges are intended to be within the scope of the subject innovation. For example, when weighted averages or terms in such weighted averages are discussed, reference to values in a range of [0,1] is frequently made, but other aspects can include weighted averages or terms thereof in other ranges, and can be equivalent, for example, by way of a linear mapping, etc.

Weighting factors can be applied to the metrics discussed herein. As such, there can be a constant portion and a dynamic portion to the calculations discussed below. The constant portion can be the weighting factor while the metric can be the dynamic portion. In some embodiments, the weighting factors can be statically or dynamically determined integer values, decimal values or the like. Additionally, the weighting factor values provided herein are example values and other different values can be used or assigned, as determined by the system designer. Regression analysis based on actual user viewing and associated metric calculations can be used to determine relative weights that provide the best predictive accuracy on one or both of an aggregate basis or an individual user basis.

In embodiments described herein, a national item can be an item submitted by a content provider that services the entire nation (e.g., CNN, ABC, etc.) and thus does not have an associated zip code (in that, although the content may originate from one or more zip codes, it is not intended to be associated with only a limited number of zip codes). Additionally, although referred to as “national,” these items are characterized in that they are not intended to be associated with geographic restrictions on where the content should appear, and can in some embodiments relate to other broad (non-nation-specific) geographic areas (e.g., global, continental, etc.). A local item can be an item with a geographic restriction on where the content should appear (e.g., a geographic restriction on areas to which the content should be distributed). In some embodiments, by default, any local affiliate stations can be limited in such a way that their content would only appear for subscribers within a certain radius (e.g., a 75-mile radius, or more or less) of the location of the local affiliate station. For hyperlocal sources serving a community with more limited geographic scope, a smaller radius may be defined for the channel. In other embodiments, a default can be set to include at least a closest affiliate of each of several types (e.g., CBS, ABC, etc.), even if outside of the radius.

The community channel quality metric can be calculated by dividing a number of views by a number of hits for the channel as a whole from the point of its inception as recorded in the [channels] table. The community channel quality metric can represent the user base's collective level of engagement in a channel's content. Implicit information can capture factors such as what the overall public thinks about a content provider's coverage (e.g., is it interesting, trustworthy, comprehensive, balanced, well-produced, etc.). These factors can lead to a greater level of engagement and increased viewing percentages. The level of engagement and viewing percentage can then be included in the calculation of the community channel quality metric.

The views field can be a running total of the portions of videos viewed. The number of views can be calculated as the sum of the decimal representation of all portions viewed. The calculation can take into account the cases wherein different users view different videos (or portions thereof) or the same user views different videos. For instance, if the channel's videos have appeared three times to three different viewers, or three different videos appeared to the same viewer, and the three videos were watched to 30%, 60%, and 100% completion, the total views are 1.9. Because the number of views can be calculated as the sum of the decimal representation of all portions viewed, 1.9 is calculated, in this embodiment, based on 30%+60%+100%=0.3+0.6+1=1.9.

While the example above is for a case wherein three different viewers watch three different videos or for the case wherein a single viewer watches three different videos, any combination of viewers and videos can be employed in the calculation as long as the calculation does not include the instance of the same user viewing the same video more than once.

The hits field can record how many times the channel's videos have been presented for viewing. In this example, the hits field would be 3. In some embodiments, the views and hits can be recorded simultaneously (or concurrently).

However, a hit can be calculated at a value of 1 regardless of the portion viewed. A view can be calculated at a value that is in the range from 0 to 1 (as described above) depending on the percentage viewed. Both can be added to the existing values as recorded in the database. Based on the above view and hits, the channel quality can be 1.9/3, or 63⅓%.

In some embodiments, new channels could be dramatically impacted in a favorable or unfavorable fashion on the metric based on the first video displayed. In other embodiments, to avoid this, an assessment of quality can be based on more than the user's response to a few videos. For example, if a user really likes CNN coverage, but the first story the user views from CNN while using the service is about a topic that is not of interest, the user may skip the story altogether. If such skipped story was the first story viewed by any user of the service from CNN, CNN could now have a quality score near 0 (in an embodiment based solely on views/hits), and it would be difficult for CNN to raise its score because (due to the low quality score) CNN's videos will appear far less frequently than other content provider's videos. As such, it could take a long time for them to obtain a score that more accurately describes CNN's true reputation with the public. Therefore, to compensate for such situations, various embodiments of the subject innovation can dynamically increase the weight that the community's channel quality carries in the metric based on the number of total hits the channel has accumulated.

The community's channel quality weighting factor can consist of a constant multiplied by the dynamic portion. In some embodiments, the constant portion can be 2 and the dynamic portion can be calculated as (1−x/(x+hits)) (or some other expression that can provide a value (e.g., between 0 and 1, etc.) that increases monotonically (e.g., linearly, etc.) as the number of hits increases) where x can be 50, though other constants and formulas can be used as determined by the system designer (e.g., to increase or decrease the relative weight of the community's channel quality, to tune these portions to change more or less rapidly per hit, etc.). As the channel accumulates hits, the calculated weighting factor will approach the constant portion, and the community's channel quality will factor more heavily in the cumulative score computed for any items from that channel. For example, using the example numbers described above, a channel with 25 hits would have a weighting factor of 2(1−50/(50+25)), or 0. 6̅, while a channel with 100 hits would have a weighting factor of 2(1−50/(50+100)), or 1. 3̅.

Another metric that can be used is the user's channel quality. The user's channel quality can be calculated much in the same way as the community channel quality, but against the user's own views and hits for the channel instead of those for all viewers. The user's own views and hits can be recorded in [userxchannel]. For example, looking only at the user's own activity on stories related to a particular channel, hits can be the number of stories presented, the views can be the sum of the decimal representation of the portions viewed (as provided above, for example, a 30% viewed story would result in a view value of 0.3), and the user's channel quality can be the ratio of views to hits. This can be calculated in the same manner as the community channel quality but uses per-user stats from [userxchannel] instead of community stats from [channel]. Like the community channel quality, the weighting factor can also be dynamically adjusted based on the number of hits the user has accumulated for the channel, but the dynamic portion of the formula used can approach 1 more quickly when the user's individual choices (e.g., as hits, etc.) are to be weighted more heavily than those of the community, as will be the case in many embodiments. A higher weighting in the formula can reflect a greater “trust” in the user metric at a lower number of hits, as it reflects actual choices by the user. In one exemplary embodiment, the weighting factor constant can be 3 (although other numbers can be used; a higher ratio of the user constant to the community one will result in more effect based on the user, and vice versa), and the dynamic portion can be calculated by the formula (1−x/(x+hits)) (or some other expression that can provide a value (e.g., between 0 and 1, etc.) that increases monotonically (e.g., linearly, etc.) as the number of hits increases), where x can be 15, etc. As will be understood, these numbers are examples, and other values can be used, where the values chosen and the relation between various metrics can be selected based on considerations discussed herein, such as to increase or decrease the influence of user or community selections, or the relative weights of various metrics, etc.

An item popularity metric can be included, for example, as a ratio of the total hits for an item as stored in the [items] table compared to the maximum number of hits achieved by any one item. To avoid unfairly penalizing content sources with a smaller geographic reach, item popularity scores can be normalized by the number of subscribers that could potentially view the content. For instance, an item with 50 hits from a community channel that covers 500 subscribers could score equally to an item with 5,000 hits from a channel with a radius that covers 50,000 subscribers. In some embodiments, items can be separated into two geographic classes, defined as national feeds and local feeds. Items from national channels, therefore, can be compared against all other items from national feeds. Items from a channel with a limited geographic scope, and therefore have at least one zip code defined, can be compared against all other items from sources with defined zip codes. In other embodiments, all items can be compared together. While it can seem unusual to score an item by popularity when the users don't get to select the items, this score can serve somewhat like a proxy for a composite community interest profile. Because there can be a bias in this metric towards more stale items, in some embodiments it can be given a relatively low weighting so as to not dramatically alter the sequence of items.

In some embodiments, the item popularity metric can be multiplied by a weighting factor. The weighting factor can be 1 in some embodiments. In other embodiments, this weighting factor (or others) can be statically or dynamically determined, integer values, decimal values or the like. Additionally, the values (e.g., 1 for the item popularity metric, etc.) are only example values, and other different values can be used or assigned (including statically or dynamically), as determined by the system designer.

One or more formulas that can incorporate any or all of the various metrics being described can be designed to alter the sequencing of items on-the-fly, dynamically, based on user feedback. However, it can help trending stories appear slightly sooner to those whose channel or keyword preferences might otherwise have suppressed the story for a while. Helping trending stories appear slightly sooner can be performed as part of the existing formula contained in [GetNextStory] to produce a composite relevancy score. This environment is different from traditional systems, because in a traditional system, the user still selects the videos they want to see from a library of content. In various embodiments of the subject innovation, the system can select the content for the users based on one or more of the various metrics described herein. Trending stories can be determined by an algorithm such as those described herein, but the degree to which a story is trending can be determined by user feedback, which can influence keyword scores, the user's channel quality, etc. In some embodiments, a community keyword score could be calculated instead of, or in addition to, this metric.

An item quality metric can be calculated as item views divided by item hits as calculated from the total number of rows for that item in the [userxitem] table. The item quality metric can be calculated for the community of users. The item quality metric, when coupled with the item popularity metric, can help identify the above-referenced trending stories (e.g., those that the system programmatically predicts the most people would like, combined with those stories that the people actually like the most).

As with the channel metrics, a dynamic weighting factor can be applied to the item quality metric. In some embodiments, the constant portion can be 2 (although greater or lesser values can be used), and the dynamic portion can be calculated by the formula (1−x/(x+hits)) (or some other expression that can provide a value (e.g., between 0 and 1, etc.) that increases monotonically (e.g., linearly, etc.) as the number of hits increases), where x can be 15, etc. In other embodiments, the weighting factor can be statically or dynamically determined integer values, decimal values or the like. Additionally, the constant and dynamic portion can represent one example weighting function and other different functions can be used or assigned, as determined by the system designer. A greater weighting factor constant can be utilized if the item quality metric is to be afforded greater weight in the calculation.

A distance score metric can be calculated as follows. Letting r be the default radius used to determine if a local content provider is near enough to a viewer to have the content provider's items displayed and d being the distance between the location (e.g., zip code, etc.) on the user's profile (in [userdata]) and the channel's location (e.g., zip code, etc.) (in [channels]), the distance score metric can be calculated as 1−(d/r). For national channels, the distance score metric can be assigned a constant somewhere in between the extremes. The extremes of this metric can be 0 and 1 in some embodiments. In some embodiments, a score that would put national content on par with local content from a station located a determined number of miles from the viewer (e.g., 40 miles from the viewer, etc.) can be used. For viewers that live within metropolitan areas, then, the advantage would go to local stations in that metro area. For those that live in more rural areas (e.g., greater than 40 miles from the nearest city), national coverage would be weighed higher than content from the city. This can allow for those who live in a city to see a higher proportion of local content, which is more likely to cover issues relevant to their immediate community than someone in distant suburbs.

Again, a constant weighting factor can be applied to the distance score metric. In some embodiments, the weighting factor can be 1. In other embodiments, the weighting factor can be statically or dynamically determined, integer values, decimal values or the like. Additionally, the value of 1 is one example value and other different values can be used or assigned, for example, as determined by the system designer. A greater weighting factor value can be utilized if the distance score metric is to be afforded greater weight in the calculation.

A keyword score metric can be used to predict the portion of a video a user may be likely to view based on the portions viewed for items the user has previously viewed that were associated with one or more keywords also present on the item being scored. One approach used in some aspects of the subject innovation can be to first identify all items with one or more keywords in common with the item being scored. Next, the similarity of each of these previously viewed items can be compared with the one being scored. A keyword vector for both items, representing the tf-idf scores for the keywords present on that item, can be created, and the cosine similarity (or some other measure such as any value that is an inner product of the normalized tf-idf vectors, etc.) can be calculated. Finally, a weighted average using item similarity as the weighting factor can be calculated for the portions viewed on each item. The overall metric's weight can vary, increasing proportional to the sum of all compared documents' similarity values.

In practice, this approach can be computationally intensive, especially as the number of documents previously viewed and/or the number of documents to be scored increase. In some embodiments, this effect can be minimized by limiting the number of previously viewed items compared for similarity by either a predetermined number or time period. This can provide for systems and methods that can adapt more quickly to a user's changing interests over time, but can also lose track of infrequently occurring topics of high interest. Some traditional systems create clusters of similar content items based on a set of sample content items. New items are then classified into one or more clusters based on their level of similarity to the cluster's average keyword characteristics. These systems then track the performance of each cluster as a whole, rather than for items individually.

For a news viewer, however, the level of interest in a story may be a function of the complex interplay of a number of different keywords present. New stories are also surfacing regularly. To accurately gauge the level of interest in a particular story thread, systems that rely primarily on clustering algorithms will need to periodically introduce new clusters to handle emerging topics. If clusters are too broadly defined, user interests may not be represented with sufficient granularity, but if clusters are too narrow, each will contain only a few items, and in cases where fuzzy clustering is used, a content items' cluster membership will begin to look roughly the same as their existing item-to-keyword relationships.

In some embodiments, the subject innovation can approximate the weighted average of portions viewed for all previously viewed items with at least one keyword in common, for example, by using a proxy function that does not decline in performance as the number of previously viewed documents increases. Given n keywords on an item to be scored, with views and hits values for each keyword in the [userxkeyword] table represented as v and h, respectively, in some embodiments, the keyword score can be calculated as

$$\frac{{\sum }_{i = 1}^{n} {v}_{i}}{{\sum }_{i = 1}^{n} {h}_{i}} .$$

For instance, an example story being scored, A, has the keywords “wildlife,” “conservation,” and “alligator.” Additionally, the user has previously viewed 3 stories containing the keyword wildlife, accumulating 1.5 views, 4 stories about conservation, accumulating 2.2 views, and 1 story about alligators, which was watched to 75% of its entirety. The keyword score according to the formula provided above is then (1.5+2.2+0.75)/(3+4+1), or 0.55625. In this formula, the portions viewed of previously viewed items sharing more than one keyword are counted multiple times in the numerator as part of the views for each common keyword, which weights the items by level of similarity. Though this weighting is slightly less accurate than calculating cosine similarity based on tf-idf vectors, the error is typically less than 0.025, and often less than 0.01, in practice with real world data.

As with the quality metrics, the weighting factor can consist of a constant and a dynamic portion for the keyword metric. In some embodiments where actual item similarity is calculated, the constant portion can be 5 (or other integer or non-integer values, as with other constant portions associated with weight factors), and the dynamic portion can be calculated by the formula (1−x/(x+t)) (or some other expression that can provide a value (e.g., between 0 and 1, etc.) that increases monotonically (e.g., linearly, etc.) as the value of t increases), where t represents the sum of all item similarity scores, and x can be 5, or some other static or dynamic value. Thus, the more similar previously viewed items are to the current item, the more significantly the keyword score factors into the overall score. Having many items with keywords in common will also increase the weighting factor. In embodiments where the keyword score is approximated using a proxy function, the dynamic portion can be calculated by (1−x/(x+0.85h/k)), where h can represent the total number of hits across all keywords on the document to be scored in [userxkeyword], x can be 5 (or vary, as above), and k can be the total number of keywords on the document to be scored. This function approximates the dynamic portion function used when similarity scores are known. In other embodiments, the weighting factor can be statically or dynamically determined integer values, decimal values or the like. Additionally, the constant and dynamic portion can represent one example weighting function and other different functions can be used or assigned, as determined by the system designer. A greater weighting factor constant can be utilized if the keyword score metric is to be afforded greater weight in the calculation, and a lesser constant if it is to be afforded lesser weight.

To ensure that the user sees a variety of content on different topics, a novelty score metric can be calculated that represents the level of freshness a particular item has for the user. To arrive at this metric, item similarity scores can be calculated for all unexpired items the user has previously viewed. These similarity scores can then be aged for a selected period of time (e.g., the first 24 hours, etc.), and the similarity score can be reduced according to one or more formulas, such as ((960+m/3)/1440) for items from different channels than the one from which the item being scored originated, or ((960+m/3)/2880) for items from the same channel, where m represents the difference between the publication date and the earlier point in time (e.g., the selected period of time ago, such as 24 hours prior to the current time, etc.) in minutes. Unexpired items older than the selected period of time (e.g., 24 hours, etc.) can use 0 for m in the calculation. Additionally, as with other values discussed herein, the 960, 3, and 1440 in the first expression, and the 960, 3 and 2880 in the second expression are examples, and can be varied. In aspects of the subject innovation, values can be chosen in the first and second expressions such that, for all times m (e.g., all times up to the selected period of time ago, with earlier times being assigned a default value such as 0, etc.), the values of the first expression can be more than that of the second expression, and both can be between can be 0 and 1 (e.g, using the example expressions with the example values provided above, the first expression linearly maps values of m to the range of [⅔, 1], and the second to the range of [⅓, ½]). In some embodiments, and for some or all items, different (e.g., nonlinear, etc.) formulas can be used to determine how much to reduce similarity scores based on age (e.g., in some “breaking news” types of situations, older items may become rapidly outdated, such as when initial information can be sparse, unreliable, etc., and thus more emphasis can be placed on more recent stories. In that or similar scenarios, greater emphasis can be placed on time differences in the most recent stories, etc.). Given a set of n similar, unexpired items with aged similarity scores s₁, s₂, . . . sₙ, the novelty score can be can be determined so as to provide a value (e.g., between 0 and 1, etc.) that increases monotonically (e.g., linearly, etc.) as the sum of those scores increases, and can become, for example,

$$1 - ( \frac{1}{1 + 3 {\sum }_{i = 1}^{n} {s}_{i}} ) .$$

In other aspects, other expressions can be used for a novelty score, such as those that increase with a greater total of aged similarity scores, and map to a range of [0, 1] or a subset thereof. The novelty score can be used such that stories that are largely the same as ones that have already been seen will be demoted. In using 2880 instead of 1440 in the aging formula for items from the same channel, the subject innovation can reduce the contribution stories from the same channel have in reducing novelty. This can be done because within a given channel, there can be better balance of story selection, and/or stories with high keyword scores can possibly be following up on an earlier story which the provider should have expired upon release of the new video. For example, assume that two items, A and B, have not expired, that A is from the same channel as the item being scored while B is not, and that A was published 12 hours ago, while B was published 6 hours ago. Assume also that A has a similarity score of 60%, while B has a similarity score of 23%. The aged similarity scores can be reduced as explained above. In one example, using the specific values of the example expressions, the aged similarity score for A is 0.6((960+720/3)/2880)=0.25, while for B it is 0.23((960+1080/3)/1440)=0.2108 3̅. The novelty score can then be calculated, and per the example expression provided above, it would be (1−1/2.3825), or approximately 0.580273.

Again, a constant weighting factor can be applied to the novelty score metric. In some embodiments, the weighting factor can be 4. In other embodiments, the weighting factor can be statically or dynamically determined, integer values, decimal values or the like. Additionally, the value of 4 is one example value and other different values can be used or assigned, as determined by the system designer. A greater weighting factor value can be utilized if the novelty score metric is to be afforded greater weight in the calculation, and a lesser value for lesser weight.

A journalistic attention score metric can be used to provide an assessment of how frequently keywords on the item being scored are also appearing on other items in the system. If k is the total number of times keywords appearing on the item being scored are assigned to unexpired items in the [keywordxitem] table and c is the total number of keywords assigned to unexpired items, the journalistic attention score can be determined so as to provide a value (e.g., between 0 and 1, etc.) that increases monotonically (e.g., linearly, etc.) as the ratio k/c increases. In one example, the journalistic attention score metric can be (1−1/(40(k/c)+1)).

Again, a constant weighting factor can be applied to the journalistic attention score metric. In some embodiments, the weighting factor can be 1. In other embodiments, the weighting factor can be statically or dynamically determined, integer values, decimal values or the like. Additionally, the value of 1 is one example value and other different values can be used or assigned, as determined by the system designer. A greater weighting factor value can be utilized if the journalistic attention score metric is to be afforded greater weight in the calculation, and a lesser value for lesser weight.

A user content score metric that promotes items that have associated user-generated content (UGC) can be included. If c is the total number of unique contributors of UGC to the item being scored, and h is the total number of hits for that item, then the user content score metric can be determined so as to provide a value (e.g., between 0 and 1, etc.) that increases monotonically (e.g., linearly, etc.) as the ratio c/h increases. In one example, the journalistic attention score metric can be calculated as (1−1/((cx/h)+1)), where x can depend on a geographic scope of a content provider, e.g., 25,000 for national content provider channels and 50,000 for any channel with a zip code assigned, or can be equal to or based at least in part on a number of users to whom items from the content provider are presented (e.g., as relative to the maximum number of hits among items presented to that number of users, etc.), etc.

As with many of the other metrics, a constant weighting factor can be applied to the user content score metric. In some embodiments, the weighting factor can be 1. In other embodiments, the weighting factor can be statically or dynamically determined, integer values, decimal values or the like. Additionally, the value of 1 is one example value and other different values can be used or assigned, as determined by the system designer. A greater weighting factor value can be utilized if the user content score metric is to be afforded greater weight in the calculation, and a lesser for lesser weight.

A social activity score metric can be included and can be calculated as the number of social network events (typically the sharing of a link to the story) related to the item being scored compared to the maximum number of social network events achieved by any one item. In some embodiments, items can be separated into two geographic classes, defined as national feeds and local feeds. In other embodiments, all items can be compared together. For local feeds when compared by geographic class, or for all feeds when compared together, the number of events can be normalized based on the total number of square miles of coverage for the channel such that the score approximates a comparison of the density of those events. For instance, an item with 250 events from a channel with a radius of 75 miles could score the same as an item with 10 events from a channel with a radius of 15 miles as the number of events per square mile are equivalent. In other aspects, the number could be normalized based on a number of users in that area, a population density, or other factors, etc.

A constant weighting factor can be applied to the social activity score metric if the item has an associated link to the content provider's page for that item. Otherwise, the weight can be 0 and this metric need not be considered. In some embodiments, the weighting factor can be 1. In other embodiments, the weighting factor can be statically or dynamically determined, integer values, decimal values or the like. Additionally, the value of 1 is one example value and other different values can be used or assigned, as determined by the system designer. A greater weighting factor value can be utilized if the social activity score metric is to be afforded greater weight in the calculation, and a lesser value for lesser weight.

A currency score metric can be included and can be computed as follows or similarly. Letting e be the number of minutes that have elapsed since the publication date and time stored in the [items] table, the currency score metric can be determined so as to provide a value (e.g., between 0 and 1, etc.) that decreases monotonically (e.g., linearly, etc.) as the value of e increases (i.e., longer elapsed time will lead to a lower metric. In one example, the currency score metric can be calculated as 1−(e/1440), although other values than 1440 can be used (which is equivalent to one day), and the expression can be optionally 0 when e is greater than 1440 (or whatever value is substituted for it). A constant weighting factor can be applied.

In some embodiments, the weighting factor by which the currency score can be multiplied can be 3. In other embodiments, the weighting factor can be statically or dynamically determined, integer values, decimal values or the like. Additionally, the value of 3 is one example value and other different values can be used or assigned, as determined by the system designer.

Referring back to FIG. 4, in another embodiment, a provision can be for user-submitted video to be added in response to a story from a content provider. This feature can be available while watching the story in the default interface through an on-screen button or link, such as the “Add My Footage” button 404 or something similar. It can also be possible for the user to enter an “upload screen” at any point in time to select a specific channel and story independently in order to upload custom videos to be transcoded by the server or CDN. This can allow for citizen journalism to be facilitated by the service.

Since this functionality can be used with mobile devices that can capture video natively, additional methods within the web services API can allow for users on mobile platforms to at least one of view or share video they have captured. Methods for one or more of retrieving all related user items for a currently playing story, uploading a video from the device in connection to a specific story, retrieving a list of all channels relevant to the user, or retrieving a list of unexpired stories for a given channel could be included to allow for this interaction from mobile applications.

Since a repository of video could be created as a result of the aggregation process, tagged with keywords, this library of video could be made searchable once the clips have expired so that they can be recalled for educational, historical, or other research purposes.

As more citizens without formal journalism training begin to cover local community issues as part of citizen journalism websites, content captured there, once the source is vetted, could also be included alongside more traditional content providers. This can be facilitated by the subject innovation, for example, via a channel's radius of influence value. In aspects, an alternative or additional approach to selecting relevant content by geography can be to abandon the radius approach altogether and use a zip code-to-DMA table to select the appropriate local market in which a user resides, then use zip code, etc. filters for the hyperlocal journalism sites. A channel might be relevant only for users in one of three zip codes, for instance.

Additionally, the data recorded for each story item could include a zip code or latitude/longitude value pair that can indicate where the story took place. Incorporating this into the metric can allow greater emphasis on stories occurring in the user's local community, regardless of the location of the source. Coupled with location-aware mobile devices that can update the user's zip-code information on-the-fly, story selection can essentially follow the user as they travel. Geotagging data associated with the location-aware mobile devices can be stored when videos are submitted and can provide a mechanism for users to see user-submitted footage from nearby locations in a dynamic interface. While they can be used together, either of these enhancements can also provide value to the end-user if implemented separately.

In some embodiments, a user interface control can also be provided that can allow users to indicate stories they wish to follow closely. This can adjust the metric in such a way that related stories get additional emphasis. It might, in one possible implementation, maintain a record of the keywords on “followed” stories for a period of time and increase the likelihood of such stories being presented, for example, by adjusting the novelty score metric in such a way that any items containing one of more of the followed keywords are not counted in the score.

For content providers, these embodiments may offer the possibility of providing new performance benchmarks that were previously unattainable or unreliable. Recent advances in technology have made it possible to track television viewing in a market to the fraction of a minute. However, viewership on any given story can either be the function of genuine interest in the story or the result of a good tease for an upcoming story for which the viewer can be patiently waiting. There is no easy way to separate the two elements. While video download statistics from the content provider's own website might be able to better provide per-story information, since requests are generated only for content desirable to the user, there can be no readily available way for them to benchmark themselves against the competition. This embodiment can offer a way to capture actual viewing time on a per-story basis without excessive network traffic because of the way videos advance in sequence. This can be difficult to do reliably in a traditional news video site because the users can click between various pages or close the window at the end of viewing. Without flooding the server with AJAX requests, only coarse statistics are possible, such as total hits or possibly if the playback crossed a certain threshold. Finally, video viewing online on a typical local station's website tends to be skewed towards the bizarre or viral videos since it can be generally still seen as a supplement to traditional viewing in most demographics. Because of its ready compatibility with video content (although, in aspects, audio or other content can also be used, etc.), the subject innovation can serve as a replacement for regular television viewing, so statistics might better reflect true user interests. A content provider portal in accordance with the subject innovation can be a valuable resource to offer for measuring viewer engagement.

While the detailed description covers various systems, methods and computer-readable storage media implementing and including and illustrating database design and/or flow of information in various embodiments, one skilled in the art will appreciate that other variations are possible and are envisaged. For example, an additional metric for category quality could be added that might be based at least in part upon a view to hit ratio for the category or be combined with the keyword score metric. Additionally, the formulas and/or constants presented can be changed as necessary for a variety of reasons, such as to adapt to changes in the number of content providers and/or the way that stories are presented to the service in an effort to optimize the experience for the end-users. Such changes to the scoring algorithm through inclusion, exclusion, or revision of metrics can be possible and are intended to be within the scope of the innovation disclosed herein.

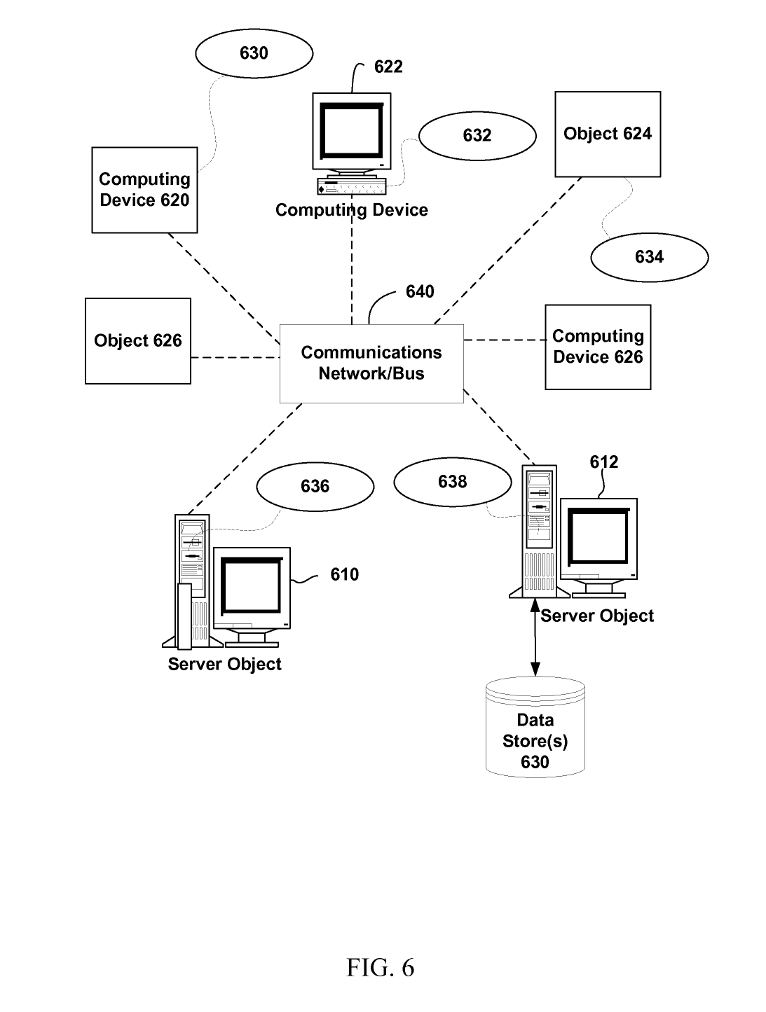

FIG. 6 provides a non-limiting schematic diagram of an example networked or distributed computing environment. One of ordinary skill in the art can appreciate that the various embodiments of methods, systems and/or apparatus described herein can be implemented in connection with any computer or other client or server device, which can be at least one of deployed as part of a computer network or in a distributed computing environment, or can be connected to any kind of data store. In this regard, the various embodiments described herein can be implemented in any computer system or environment having any number of memory or storage units, and/or any number of applications and/or processes occurring across any number of storage units. This includes, but is not limited to, an environment with server computers and/or client computers deployed in a network environment or a distributed computing environment, having remote or local storage.

Referring to FIG. 6, a distributed computing environment useable in connection with the subject application can comprise one or more server objects 610, 612. The distributed computing environment can also comprise one or more computing objects or computing devices 620, 622, 624, 626, 628, which can include, but are not limited to, at least one of programs, methods, data stores, programmable logic, etc., as represented by applications 630, 632, 634, 636, 638. It can be appreciated that the one or more computing objects or computing devices 620, 622, 624, 626, 628, etc. can be included in different devices, such as personal digital assistants (PDAs), digital video disks (DVDs), compact discs (CDs), audio/video devices, mobile phones, Moving Picture Experts Group Audio Layer III (MP3) players, laptops, etc.

At least one of the one or more server object 610, 612, etc. or computing objects or devices 620, 622, 624, 626, 628, etc. can communicate with at least another of the one or more other server objects 610, 612, etc. or computing objects or computing devices 620, 622, 624, 626, 628, etc. by way of the communications network 640, either directly or indirectly. Even though illustrated as a single element in FIG. 6, network 640 can comprise one or more additional computing objects or computing devices that can provide services to the system of FIG. 6, and/or can represent multiple interconnected networks, which are not shown. One or more objects 610, 612, etc. or one or more computing objects or devices 620, 622, 624, 626, 628, etc. can also contain an application, such as at least one of applications 630, 632, 634, 636, 638, that might make use of one or more of an API, or other object, software, firmware or hardware, suitable for communication with or implementation of an infrastructure for information as a service from any platform as provided in accordance with various embodiments.

There are a variety of systems, components, and/or network configurations that support distributed computing environments. For example, computing systems can be connected together by wired or wireless systems, by local networks or widely distributed networks. Currently, many networks are coupled to the Internet, which provides an infrastructure for widely distributed computing and/or encompasses many different networks, though any network infrastructure can be used for exemplary communications made incident to the techniques as described in various embodiments.

Thus, one or more of a variety of network topologies and/or network infrastructures, such as client/server, peer-to-peer, or hybrid architectures, can be utilized. In a client/server architecture, a client can be a computer that accesses shared network resources provided by another computer, e.g., a server. In the illustration of FIG. 6, as a non-limiting example, one or more computing objects or devices 620, 622, 624, 626, 628, etc. can be regarded as clients and/or objects, while 610, 612, etc. can be regarded as servers, wherein servers, etc. can provide data services, which can include one or more of receiving data from client computing objects or devices 620, 622, 624, 626, 628, etc., storing of data, processing of data, transmitting data to client computing objects or devices 620, 622, 624, 626, 628, etc., although any computer can be considered a client, a server, or both, depending on the circumstances. Any of these computing devices can be processing data, or requesting services or tasks that can implicate an infrastructure for information as a service from any platform and/or related techniques as described herein for one or more embodiments.

A server can be typically a computer system accessible over a remote or local network, such as the Internet or wired or wireless network infrastructures. The client process can be active in a first computer system, and/or the server process can be active in a second computer system, communicating with one another over a communications medium, thus providing distributed functionality and/or allowing multiple clients to take advantage of the information-gathering capabilities of the server.

In a network environment in which the communications network/bus 640 can be the Internet, for example, the servers etc. can be Web servers with which the client computing objects or devices 620, 622, 624, 626, 628, etc. communicate via any of a number of known protocols, such as HTTP. Servers etc. can also serve as client computing objects or devices 620, 622, 624, 626, 628, etc., as can be characteristic of a distributed computing environment.

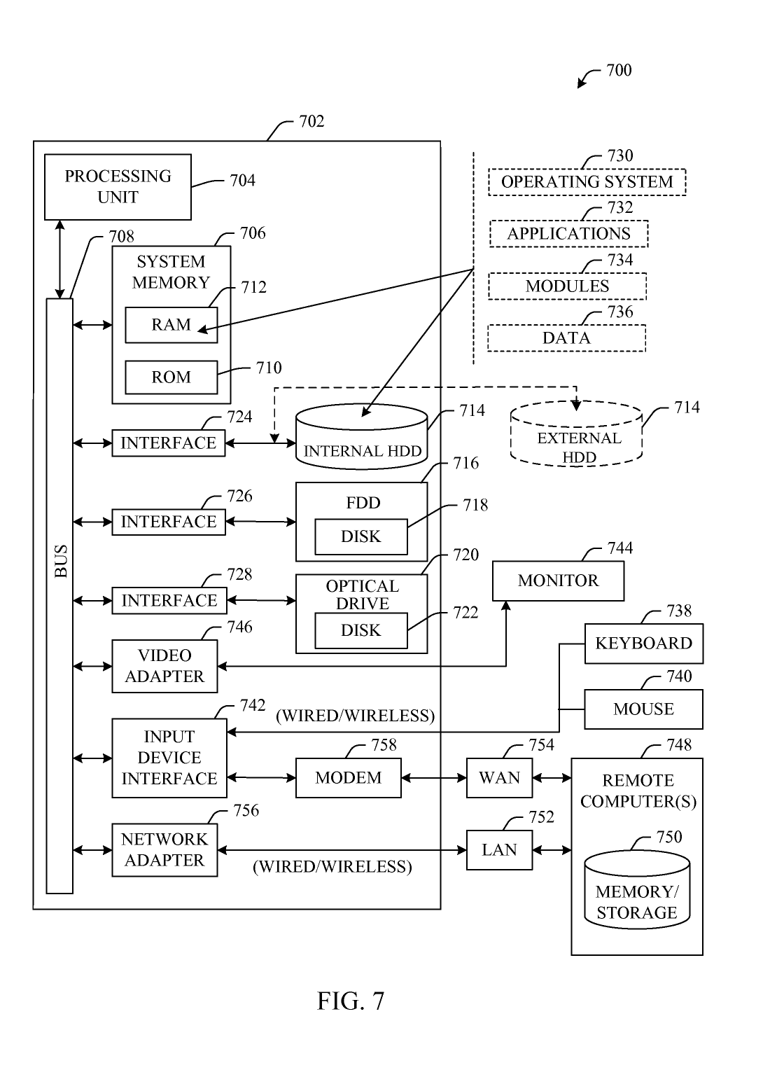

Referring now to FIG. 7, there is illustrated a block diagram of a computer operable to execute the disclosed architecture. In order to provide additional context for various aspects of the subject innovation, FIG. 7 and the following discussion are intended to provide a brief, general description of a suitable computing environment 700 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 7, the exemplary environment 700 for implementing various aspects of the innovation includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi-processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 includes read-only memory (ROM) 710 and random access memory (RAM) 712. A basic input/output system (BIOS) is stored in a non-volatile memory 710 such as ROM, EPROM, EEPROM, which BIOS contains the basic routines that help to transfer information between elements within the computer 702, such as during start-up. The RAM 712 can also include a high-speed RAM such as static RAM for caching data.

The computer 702 further includes an internal hard disk drive (HDD) 714 (e.g., EIDE, SATA), which internal hard disk drive 714 may also be configured for external use in a suitable chassis (not shown), a magnetic floppy disk drive (FDD) 716, (e.g., to read from or write to a removable diskette 718) and an optical disk drive 720, (e.g., reading a CD-ROM disk 722 or, to read from or write to other high capacity optical media such as the DVD). The hard disk drive 714, magnetic disk drive 716 and optical disk drive 720 can be connected to the system bus 708 by a hard disk drive interface 724, a magnetic disk drive interface 726 and an optical drive interface 728, respectively. The interface 724 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 712, including an operating system 730, one or more application programs 732, other program modules 734 and program data 736. All or portions of the operating system, applications, modules, and/or data can also be cached in the RAM 712. It is appreciated that the innovation can be implemented with various commercially available operating systems or combinations of operating systems.

A user can enter commands and information into the computer 702 through one or more wired/wireless input devices, e.g., a keyboard 738 and a pointing device, such as a mouse 740. Other input devices (not shown) may include a microphone, an IR remote control, a joystick, a game pad, a stylus pen, touch screen, or the like. These and other input devices are often connected to the processing unit 704 through an input device interface 742 that is coupled to the system bus 708, but can be connected by other interfaces, such as a parallel port, an IEEE 1394 serial port, a game port, a USB port, an IR interface, etc.

A monitor 744 or other type of display device is also connected to the system bus 708 via an interface, such as a video adapter 746. In addition to the monitor 744, a computer typically includes other peripheral output devices (not shown), such as speakers, printers, etc.

The computer 702 may operate in a networked environment using logical connections via wired and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wired/wireless connectivity to a local area network (LAN) 752 and/or larger networks, e.g., a wide area network (WAN) 754. Such LAN and WAN networking environments are commonplace in offices and companies, and facilitate enterprise-wide computer networks, such as intranets, all of which may connect to a global communications network, e.g., the Internet.

When used in a LAN networking environment, the computer 702 is connected to the local network 752 through a wired and/or wireless communication network interface or adapter 756. The adapter 756 may facilitate wired or wireless communication to the LAN 752, which may also include a wireless access point disposed thereon for communicating with the wireless adapter 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wired or wireless device, is connected to the system bus 708 via the serial port interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices. As mentioned above, while some example embodiments have been described in connection with various computing devices, networks and/or advertising architectures, the underlying concepts can be applied to any network system and/or any computing device or system in which it can be desirable to augment reality via a secondary channel.

There are multiple ways of implementing one or more of the embodiments described herein, e.g., an appropriate API, tool kit, driver code, operating system, control, standalone or downloadable software object, etc. which can enable applications and/or services to use a framework for augmenting reality via a secondary channel. Embodiments can be contemplated from the standpoint of an API (or other software object), as well as from a software or hardware object that provides pointing platform services in accordance with one or more of the described embodiments. Various implementations and/or embodiments described herein can have aspects that are wholly in hardware, partly in hardware and/or partly in software, as well as in software.

Although certain specific examples are provided herein to illustrate aspects of the subject innovation, the subject matter disclosed herein is not limited by such examples. In addition, any aspect or design described herein is not necessarily to be construed as preferred or advantageous over other aspects or designs, nor is it meant to preclude equivalent exemplary structures and/or techniques that would be apparent to those of ordinary skill in the art in light of the teachings herein. Furthermore, to the extent that the terms “includes,” “has,” “contains,” and/or other similar words are used in either the detailed description or the claims, for the avoidance of doubt, such terms are intended to be inclusive in a manner similar to the term “comprising” as an open transition word without precluding any additional or other elements.

As used herein, the terms “infer” or “inference” refer generally to the process of reasoning about or inferring states of the system, apparatus, method, environment, and/or user from a set of observations as captured via events and/or data. By way of examples, but not limitation, inference can be employed to identify a specific context or action, or can generate a probability distribution over states. The inference can be probabilistic (e.g., the computation of a probability distribution over states of interest based on a consideration of data and/or events). Inference can also refer to techniques employed for composing higher-level events from a set of events and/or data. Such inference can result in the construction of new events or actions from a set of observed events and/or stored event data, whether or not the events are correlated in close temporal proximity, and/or whether the events and/or data come from one or several event and/or data sources.

Furthermore, the embodiments can be implemented as a method, apparatus or article of manufacture using standard programming and/or engineering techniques to produce software, firmware, hardware, or any combination thereof to control a computer, apparatus or article of manufacture to implement the functionality disclosed herein. The term “article of manufacture,” as used herein, can be intended to encompass a computer program, or computer program product, accessible from any computer-readable device, computer-readable carrier, computer-readable media or computer-readable storage media.

As mentioned, the various techniques described herein can be implemented in connection with hardware or software or, where appropriate, with a combination of both. As used herein, the terms “component,” “system” and/or the like are likewise intended to refer to a computer-related entity, either hardware, a combination of hardware and/or software, software, or software in execution. For example, a component can be, but is not limited to being, a process running on a processor, a processor, an object, an executable, a thread of execution, a program, and/or a computer. By way of illustration, both an application running on computer and/or the computer can be a component. One or more components can reside within a process and/or thread of execution and/or a component can be localized on one computer and/or distributed between two or more computers.

The aforementioned systems have been described with respect to interaction between several components. It can be appreciated that such systems and/or components can include those components or specified sub-components, some of the specified components or sub-components, and/or additional components, and/or according to various permutations and/or combinations of the foregoing. Sub-components can also be implemented as components communicatively coupled to other components rather than included within parent components (hierarchical). Additionally, it can be to be noted that one or more components can be combined into a single component providing aggregate functionality or divided into several separate sub-components, and/or any one or more middle layers, such as a management layer, can be provided to communicatively couple to such sub-components in order to provide integrated functionality. Any components described herein can also interact with one or more other components not specifically described herein but generally known by those of skill in the art.

While in some embodiments, a client side perspective can be illustrated, it can be to be understood for the avoidance of doubt that a corresponding server perspective exists, or vice versa. Similarly, where a method can be practiced, a corresponding device can be provided having storage and/or at least one processor configured to practice that method via one or more components.

While the various embodiments have been described in connection with various embodiments of the various figures, it can be to be understood that other similar embodiments can be used or modifications and/or additions can be made to the described embodiment for performing the same function without deviating therefrom. Still further, one or more aspects of the above described embodiments can be implemented in or across a plurality of processing chips or devices, and/or storage can similarly be affected across a plurality of devices. Therefore, the subject innovation is not to be limited to any single embodiment, but rather can be to be construed in breadth and/or scope in accordance with the appended claims.

Further, what has been described above includes embodiments of claimed subject matter. It is, of course, not possible to describe every conceivable combination of components or methodologies for purposes of describing the claimed subject matter. However, one of ordinary skill in the art can recognize that many further combinations and/or permutations of such subject matter are possible. Accordingly, the subject matter can be intended to embrace all such alterations, modifications and/or variations that fall within the spirit and/or scope of the appended claims. Furthermore, to the extent that the term “includes” can be used in either the detailed description or the claims, such term can be intended to be inclusive in a manner similar to the term “comprising” as “comprising” can be interpreted when employed as a transitional word in a claim.

What is claimed is:

1. A system configured to present news content, the system comprising:
at least one processor coupled to a memory, the at least one processor executing instructions associated with:
at least one download server communicatively coupled to one or more content providers that provide the news content, wherein the at least one download server downloads at least a portion of the news content;
a database that comprises information related to at least a subset of the downloaded news content and to one or more users;
a content delivery network that stores at least a portion of the downloaded news content; and
a web server configured to present an item of the at least a portion of the downloaded news content to a user device, wherein the item is selected by the database as a highest scoring item in response to a query sent to the database, and wherein the scoring of the item is based at least in part on a weighted average of one or more metrics.

2. The system of claim 1, wherein each metric of the one or more metrics comprises a constant portion and a dynamic portion.

3. The system of claim 1, wherein the web server is configured to receive user generated content associated with the item.

4. The system of claim 1, wherein the one or more content providers comprise at least one national content provider and at least one local content provider.

5. The system of claim 4, wherein a first metric of the one or more metrics applies a first formula for a first portion of the news content associated with the national content provider and applies a second formula for a second portion of the news content associated with the local content provider, wherein the first formula is distinct from the second formula.

6. The system of claim 1, wherein the web server is communicatively coupled to an advertising server, and the web server is configured to present, in connection with the item, an advertisement received from the advertising server.

7. The system of claim 1, wherein the download server receives structured data associated with the news content from the one or more content providers, and wherein the structured data comprises one or more keywords associated with the news content.

8. The system of claim 7, wherein the structured data comprises information presented in at least one of an extensible markup language (XML) format or a media real simple syndication (mRSS) format.

9. The system of claim 7, wherein the one or more keywords are parsed, and wherein the database stores the one or more parsed keywords and associates the one or more parsed keywords with at least a portion of the subset of the downloaded news content and the one or more users.

10. The system of claim 1, wherein the one or more metrics comprise one or more of a community channel quality metric, a user channel quality metric, an item popularity metric, a distance score metric, a keyword score metric, a novelty score metric, a journalistic attention score metric, a user content score metric, a social activity score metric, or a currency score metric.

11. A method of presenting personalized news content, comprising:
storing computer executable instructions on a memory;
employing a processor that executes the computer executable instructions stored on the memory to implement the following acts:
connecting to one or more content providers over a network;
receiving structured data associated with the news content from the one or more content providers;
updating a database based at least in part on the structured data received from the one or more content providers;
downloading at least a portion of the news content to a content delivery network or one or more edge servers;
selecting a next video from among the news content, wherein the next video is selected based at least in part on a weighted average of one or more metrics, wherein the one or more metrics are calculated based at least in part on information stored in the updated database; and
presenting the next video to a user.

12. The method of claim 11, further comprising updating the database based on one or more of a portion of the next video viewed by the user, or whether the user viewed the next video.

13. The method of claim 11, further comprising receiving user generated content associated with the next video.

14. The method of claim 11, further comprising parsing one or more keywords associated with the news content, and associating the parsed keywords in the database with the news content and the user.

15. The method of claim 11, wherein the structured data comprises information presented in at least one of an extensible markup language (XML) format or a media real simple syndication (mRSS) format.

16. The method of claim 11, further comprising presenting an advertisement to the user in connection with the next video.

17. The method of claim 11, wherein the one or more content providers comprises at least two content providers of differing geographic scopes, and wherein a score of at least a first metric of the one or more metrics varies based at least in part on the differing geographic scopes.

18. The method of claim 11, wherein at least one metric of the one or more metrics comprises a constant portion and a dynamic portion.

19. The method of claim 11, wherein the one or more metrics comprise at least one of a community channel quality metric, a user channel quality metric, an item popularity metric, a distance score metric, a keyword score metric, a novelty score metric, a journalistic attention score metric, a user content score metric, a social activity score metric, or a currency score metric.

20. A system configured to present personalized news items, comprising:
at least one processor coupled to a memory, the at least one processor executing instructions associated with:
at least one download server that downloads the news items and receives structured data comprising one or more keywords associated with the news items, wherein the download server parses the keywords;
a database that stores data associated with the news items, the associated keywords, and one or more users;
a content delivery network that stores at least a portion of the downloaded news content at the content delivery network or one or more associated edge servers; and
a web server that presents a selected item of the news items to a device associated with a first user of the one or more users, wherein the item is selected as the highest scoring news item of the news items, wherein the score is determined based at least in part in response to a query to the database, and wherein the score is a weighted average of a plurality of metrics.
